(19) United States
(12) Patent Application Publication
(10) Pub. No.: US 2026/0006238 A1
(43) Pub. Date: Jan. 1, 2026

(54) Motion Vector Difference Indication

(71) Applicant: Ofinno, LLC, Reston, VA (US)

(72) Inventors: Alexey Konstantinovich Filippov, Khimki (RU); Vasily Alexeevich Rufitskiy, Vladimir (RU); Esmael Hejazi Dinan, McLean, VA (US)

(73) Assignee: Ofinno, LLC, Reston, VA (US)

(21) Appl. No.: 19/318,044

(22) Filed: Sep. 3, 2025

Related U.S. Application Data
(63) Continuation of application No. PCT/US2024/017831, filed on Feb. 29, 2024.
(60) Provisional application No. 63/449,942, filed on Mar. 3, 2023.

(51) Int. Cl. H04N 19/513; H04N 19/176; H04N 19/184

(52) U.S. Cl. CPC H04N 19/513; H04N 19/176; H04N 19/184

(57) ABSTRACT

In video coding, current blocks may be decoded in an inter prediction mode using a motion vector difference (MVD). A decoder receives, in a bitstream, one indicator indicating whether an absolute value of each component of the MVD is greater than zero. Based on the received indictor, the decoder determines the MVD for the current block. Similarly, current blocks may be decoded in an intra mode such as intra block copy using a block vector difference (BVD). The decoder receives, in the bitstream, one indicator indicating whether an absolute value of each component of the BVD is greater than zero. Based on the received indictor, the decoder determines the BVD for the current block.

### CROSS-REFERENCE TO RELATED APPLICATIONS

This application is a continuation of International Application No. PCT/US2024/017831, filed Feb. 29, 2024, which claims the benefit of U.S. Provisional Application No. 63/449,942, filed Mar. 3, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary video coding/decoding system in which embodiments of the present disclosure may be implemented.

FIG. 2 illustrates an exemplary encoder in which embodiments of the present disclosure may be implemented.

FIG. 3 illustrates an exemplary decoder in which embodiments of the present disclosure may be implemented.

FIG. 4 illustrates an example quadtree partitioning of a coding tree block (CTB) in accordance with embodiments of the present disclosure.

FIG. 5 illustrates a corresponding quadtree of the example quadtree partitioning of the CTB in FIG. 4 in accordance with embodiments of the present disclosure.

FIG. 6 illustrates example binary and ternary tree partitions in accordance with embodiments of the present disclosure.

FIG. 7 illustrates an example quadtree+multi-type tree partitioning of a CTB in accordance with embodiments of the present disclosure.

FIG. 8 illustrates a corresponding quadtree+multi-type tree of the example quadtree+multi-type tree partitioning of the CTB in FIG. 7 in accordance with embodiments of the present disclosure.

FIG. 9 illustrates an example set of reference samples determined for intra prediction of a current block being encoded or decoded in accordance with embodiments of the present disclosure.

FIG. 10A illustrates the 35 intra prediction modes supported by HEVC in accordance with embodiments of the present disclosure.

FIG. 10B illustrates the 67 intra prediction modes supported by HEVC in accordance with embodiments of the present disclosure.

FIG. 11 illustrates the current block and reference samples from FIG. 9 in a two-dimensional x, y plane in accordance with embodiments of the present disclosure.

FIG. 12 illustrates an example angular mode prediction of the current block from FIG. 9 in accordance with embodiments of the present disclosure.

FIG. 13A illustrates an example of inter prediction performed for a current block in a current picture being encoded in accordance with embodiments of the present disclosure.

FIG. 13B illustrates an example horizontal component and vertical component of a motion vector in accordance with embodiments of the present disclosure.

FIG. 14 illustrates an example of bi-prediction, performed for a current block in accordance with embodiments of the present disclosure.

FIG. 15A illustrates an example location of five spatial candidate neighboring blocks relative to a current block being coded in accordance with embodiments of the present disclosure.

FIG. 15B illustrates an example location of two temporal, co-located blocks relative to a current block being coded in accordance with embodiments of the present disclosure.

FIG. 16 illustrates an example of IBC applied for screen content in accordance with embodiments of the present disclosure.

FIG. 17 illustrates an example of IBC coding using a block vector difference (BVD), according to some embodiments.

FIG. 18 illustrates an example implementation of a context-based adaptive binary arithmetic coding (CABAC) encoder, according to some embodiments.

FIG. 19 illustrates an example of syntax elements of a motion vector difference (MVD), according to some embodiments.

FIG. 20 illustrate an example of syntax elements of a block vector difference (BVD), according to some embodiments.

FIG. 21 illustrates an example of syntax elements indicating a merge mode or an advanced motion vector prediction (AMVP) mode, according to some embodiments.

FIG. 22 illustrates an example of context coding a second indicator, indicating whether a second component of an MVD is zero, based on a first indicator indicating whether a first component of the MVD is zero, according to some embodiments.

FIG. 23A illustrates an example of an indicator that jointly indicates whether a first component of the MVD is greater than zero and whether a second component of the MVD is greater than zero, according to some embodiments.

FIG. 23B illustrates an example of an indicator that jointly indicates whether a first component of the MVD is greater than zero and whether a second component of the MVD is greater than zero, according to some embodiments.

FIG. 24 illustrates an example of an Ex-Golomb code used for coding a vector difference such as a BVD or an MVD, according to some embodiments.

FIG. 25 illustrates an example table showing bit-lengths of codewords of an entropy code used for coding a vector difference such as a BVD or an MVD, according to some embodiments.

FIG. 26 illustrates a flowchart of a method for encoding an MVD, according to some embodiments.

FIG. 27 illustrates a flowchart of a method for decoding an MVD, according to some embodiments.

FIG. 28 illustrates a flowchart of a method for encoding an MVD, according to some embodiments.

FIG. 29 illustrates a flowchart of a method for decoding an MVD, according to some embodiments.

FIG. 30 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Representing a video sequence in digital form may require a large number of bits. The data size of a video sequence in digital form may be too large for storage and/or transmission in many applications. Video encoding may be used to compress the size of a video sequence to provide for more efficient storage and/or transmission. Video decoding may be used to decompress a compressed video sequence for display and/or other forms of consumption.

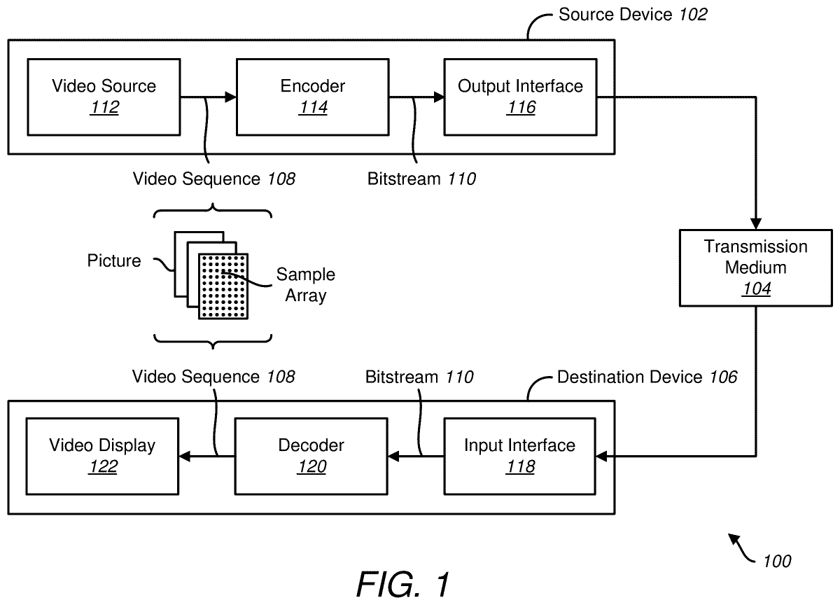

FIG. 1 illustrates an exemplary video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and destination device 106 may be any one of a number of different devices, including a desktop computer, laptop computer, tablet computer, smart phone, wearable device, television, camera, video gaming console, set-top box, or video streaming device.

To encode video sequence 108 into bitstream 110, source device 102 may comprise a video source 112, an encoder 114, and an output interface 116. Video source 112 may provide or generate video sequence 108 from a capture of a natural scene and/or a synthetically generated scene. A synthetically generated scene may be a scene comprising computer generated graphics or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A shown in FIG. 1, a video sequence, such as video sequence 108, may comprise a series of pictures (also referred to as frames). A video sequence may achieve the impression of motion when a constant or variable time is used to successively present pictures of the video sequence. A picture may comprise one or more sample arrays of intensity values. The intensity values may be taken at a series of regularly spaced locations within a picture. A color picture typically comprises a luminance sample array and two chrominance sample arrays. The luminance sample array may comprise intensity values representing the brightness (or luma component, Y) of a picture. The chrominance sample arrays may comprise intensity values that respectively represent the blue and red components of a picture (or chroma components, Cb and Cr) separate from the brightness. Other color picture sample arrays are possible based on different color schemes (e.g., an RGB color scheme). For color pictures, a pixel may refer to all three intensity values for a given location in the three sample arrays used to represent color pictures. A monochrome picture comprises a single, luminance sample array. For monochrome pictures, a pixel may refer to the intensity value at a given location in the single, luminance sample array used to represent monochrome pictures.

Encoder 114 may encode video sequence 108 into bitstream 110. To encode video sequence 108, encoder 114 may apply one or more prediction techniques to reduce redundant information in video sequence 108. Redundant information is information that may be predicted at a decoder and therefore may not be needed to be transmitted to the decoder for accurate decoding of the video sequence. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Before applying the one or more prediction techniques, encoder 114 may partition pictures of video sequence 108 into rectangular regions referred to as blocks. Encoder 114 may then encode a block using one or more of the prediction techniques.

For temporal prediction, encoder 114 may search for a block similar to the block being encoded in another picture (also referred to as a reference picture) of video sequence 108. The block determined during the search (also referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (also referred to as a residual) based on the difference between a block being encoded and a prediction block. The prediction error may represent non-redundant information that may be transmitted to a decoder for accurate decoding of a video sequence.

Encoder 114 may apply a transform to the prediction error (e.g. a discrete cosine transform (DCT)) to generate transform coefficients. Encoder 114 may form bitstream 110 based on the transform coefficients and other information used to determine prediction blocks (e.g., prediction types, motion vectors, and prediction modes). In some examples, encoder 114 may perform one or more of quantization and entropy coding of the transform coefficients and/or the other information used to determine prediction blocks before forming bitstream 110 to further reduce the number of bits needed to store and/or transmit video sequence 108.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into video sequence 108 for display, destination device 106 may comprise an input interface 118, a decoder 120, and a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode video sequence 108 from encoded bitstream 110. To decode video sequence 108, decoder 120 may generate prediction blocks for pictures of video sequence 108 in a similar manner as encoder 114 and determine prediction errors for the blocks. Decoder 120 may generate the prediction blocks using prediction types, prediction modes, and/or motion vectors received in bitstream 110 and determine the prediction errors using transform coefficients also received in bitstream 110. Decoder 120 may determine the prediction errors by weighting transform basis functions using the transform coefficients. Decoder 120 may combine the prediction blocks and prediction errors to decode video sequence 108. In some examples, decoder 120 may decode a video sequence that approximates video sequence 108 due to, for example, lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, liquid crystal display (LCD), a plasma display, light emitting diode (LED) display, or any other display device suitable for displaying video sequence 108.

It should be noted that video encoding/decoding system 100 is presented by way of example and not limitation. In the example of FIG. 1, video encoding/decoding system 100 may have other components and/or arrangements. For example, video source 112 may be external to source device 102. Similarly, video display 122 may be external to destination device 106 or omitted altogether where video sequence is intended for consumption by a machine and/or storage device. In another example, source device 102 may further comprise a video decoder and destination device 106 may comprise a video encoder. In such an example, source device 102 may be configured to further receive an encoded bit stream from destination device 106 to support two-way video transmission between the devices.

In the example of FIG. 1, encoder 114 and decoder 120 may operate according to any one of a number of proprietary or industry video coding standards. For example, encoder 114 and decoder 120 may operate according to one or more of International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC), ITU-T H.265 and MPEG-I Part 3 (also known as Versatile Video Coding (VVC)), the WebM VP8 and VP9 codecs, and AOMedia Video 1 (AV1).

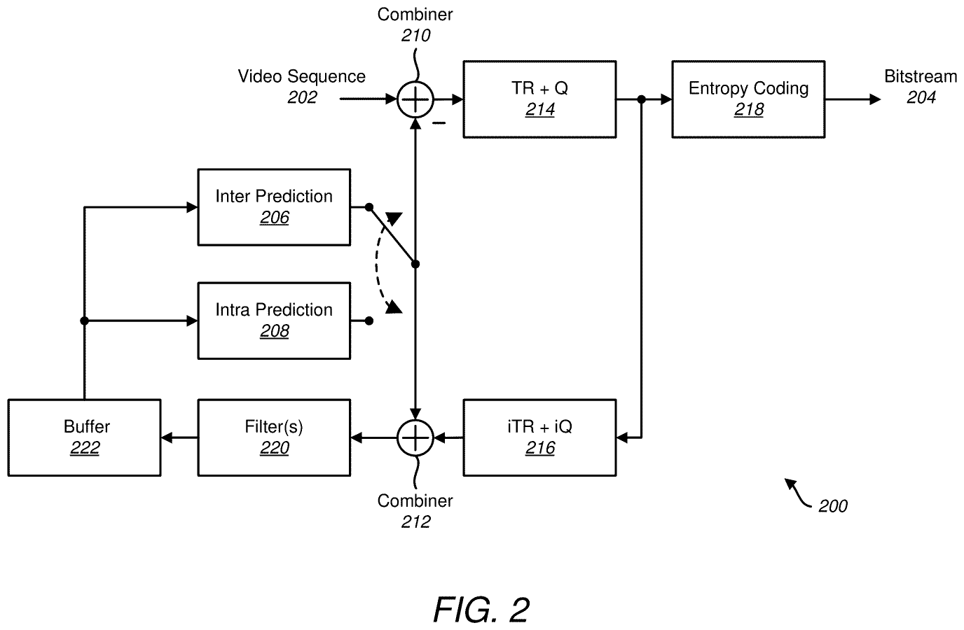

FIG. 2 illustrates an exemplary encoder 200 in which embodiments of the present disclosure may be implemented. Encoder 200 encodes a video sequence 202 into a bitstream 204 for more efficient storage and/or transmission. Encoder 200 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Encoder 200 comprises an inter prediction unit 206, an intra prediction unit 208, combiners 210 and 212, a transform and quantization unit (TR+Q) unit 214, an inverse transform and quantization unit (iTR+iQ) 216, entropy coding unit 218, one or more filters 220, and a buffer 222.

Encoder 200 may partition the pictures of video sequence 202 into blocks and encode video sequence 202 on a block-by-block basis. Encoder 200 may perform a prediction technique on a block being encoded using either inter prediction unit 206 or intra prediction unit 208. Inter prediction unit 206 may perform inter prediction by searching for a block similar to the block being encoded in another, reconstructed picture (also referred to as a reference picture) of video sequence 202. A reconstructed picture refers to a picture that was encoded and then decoded. The block determined during the search (also referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

After prediction, combiner 210 may determine a prediction error (also referred to as a residual) based on the difference between the block being encoded and the prediction block. The prediction error may represent non-redundant information that may be transmitted to a decoder for accurate decoding of a video sequence.

Transform and quantization unit 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. Irrelevant information is information that may be removed from the coefficients without producing visible and/or perceptible distortion in video sequence 202 after decoding.

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and syntax-based context-based binary arithmetic coding (SBAC). The entropy coded coefficients are packed to form bitstream 204.

Inverse transform and quantization unit 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block using, for example, a deblocking filter and/or a sample-adaptive offset (SAO) filter. Buffer 222 may store the reconstructed block for prediction of one or more other blocks in the same and/or different picture of video sequence 202.

Although not shown in FIG. 2, encoder 200 further comprises an encoder control unit configured to control one or more of the units of encoder 200 shown in FIG. 2. The encoder control unit may control the one or more units of encoder 200 such that bitstream 204 is generated in conformance with the requirements of any one of a number of proprietary or industry video coding standards. For example, The encoder control unit may control the one or more units of encoder 200 such that bitstream 204 is generated in conformance with one or more of ITU-T H.263, AVC, HEVC, VVC, VP8, VP9, and AV1 video coding standards.

Within the constraints of a proprietary or industry video coding standard, the encoder control unit may attempt to minimize or reduce the bitrate of bitstream 204 and maximize or increase the reconstructed video quality. For example, the encoder control unit may attempt to minimize or reduce the bitrate of bitstream 204 given a level that the reconstructed video quality may not fall below, or attempt to maximize or increase the reconstructed video quality given a level that the bit rate of bitstream 204 may not exceed. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and one or more transform types and/or quantization parameters applied by transform and quantization unit 214. The encoder control unit may determine/control the above based on how the determination/control effects a rate-distortion measure for a block or picture being encoded. The encoder control unit may determine/control the above to reduce the rate-distortion measure for a block or picture being encoded.

After being determined, the prediction type used to encode a block (intra or inter prediction), prediction information of the block (intra prediction mode if intra predicted, motion vector, etc.), and transform and quantization parameters, may be sent to entropy coding unit 218 to be further compressed to reduce the bit rate. The prediction type, prediction information, and transform and quantization parameters may be packed with the prediction error to form bitstream 204.

It should be noted that encoder 200 is presented by way of example and not limitation. In other examples, encoder 200 may have other components and/or arrangements. For example, one or more of the components shown in FIG. 2 may be optionally included in encoder 200, such as entropy coding unit 218 and filters(s) 220.

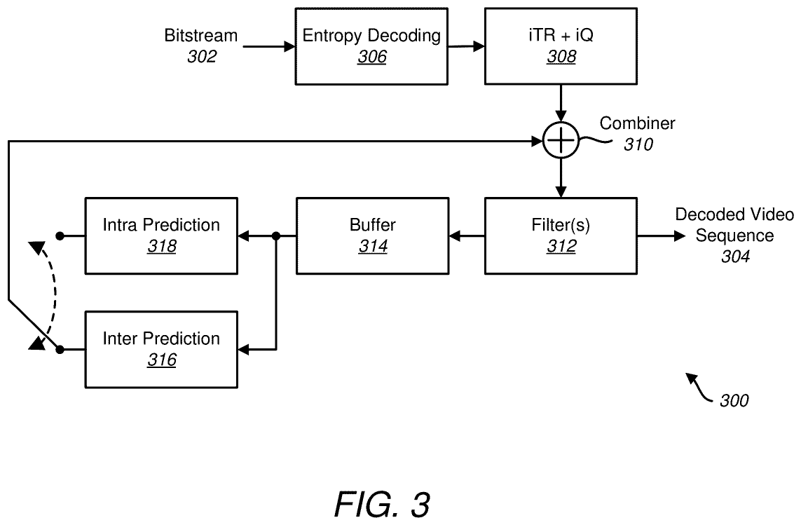

FIG. 3 illustrates an exemplary decoder 300 in which embodiments of the present disclosure may be implemented. Decoder 300 decodes a bitstream 302 into a decoded video sequence 304 for display and/or some other form of consumption. Decoder 300 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Decoder 300 comprises an entropy decoding unit 306, an inverse transform and quantization (iTR+iQ) unit 308, a combiner 310, one or more filters 312, a buffer 314, an inter prediction unit 316, and an intra prediction unit 318.

Although not shown in FIG. 3, decoder 300 further comprises a decoder control unit configured to control one or more of the units of decoder 300 shown in FIG. 3. The decoder control unit may control the one or more units of decoder 300 such that bitstream 302 is decoded in conformance with the requirements of any one of a number of proprietary or industry video coding standards. For example, The decoder control unit may control the one or more units of decoder 300 such that bitstream 302 is decoded in conformance with one or more of ITU-T H.263, AVC, HEVC, VVC, VP8, VP9, and AV1 video coding standards.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. Inverse transform and quantization unit 308 may inverse quantize and inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 as described above with respect to encoder 200 in FIG. 2. Filter(s) 312 may filter the decoded block using, for example, a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

It should be noted that decoder 300 is presented by way of example and not limitation. In other examples, decoder 300 may have other components and/or arrangements. For example, one or more of the components shown in FIG. 3 may be optionally included in decoder 300, such as entropy decoding unit 306 and filters(s) 312.

It should be further noted that, although not shown in FIGS. 2 and 3, each of encoder 200 and decoder 300 may further comprise an intra block copy unit in addition to inter prediction and intra prediction units. The intra block copy unit may perform similar to an inter prediction unit but predict blocks within the same picture. For example, the intra block copy unit may exploit repeated patterns that appear in screen content. Screen content may include, for example, computer generated text, graphics, and animation.

As mentioned above, video encoding and decoding may be performed on a block-by-block basis. The process of partitioning a picture into blocks may be adaptive based on the content of the picture. For example, larger block partitions may be used in areas of a picture with higher levels of homogeneity to improve coding efficiency.

In HEVC, a picture may be partitioned into non-overlapping square blocks, referred to as coding tree blocks (CTBs), comprising samples of a sample array. A CTB may have a size of 2n×2n samples, where n may be specified by a parameter of the encoding system. For example, n may be 4, 5, or 6. A CTB may be further partitioned by a recursive quadtree partitioning into coding blocks (CBs) of half vertical and half horizontal size. The CTB forms the root of the quadtree. A CB that is not split further as part of the recursive quadtree partitioning may be referred to as a leaf-CB of the quadtree and otherwise as a non-leaf CB of the quadtree. A CB may have a minimum size specified by a parameter of the encoding system. For example, a CB may have a minimum size of 4×4, 8×8, 16×16, 32×32, or 64×64 samples. For inter and intra prediction, a CB may be further partitioned into one or more prediction blocks (PBs) for performing inter and intra prediction. A PB may be a rectangular block of samples on which the same prediction type/mode may be applied. For transformations, a CB may be partitioned into one or more transform blocks (TBs). A TB may be a rectangular block of samples that may determine an applied transform size.

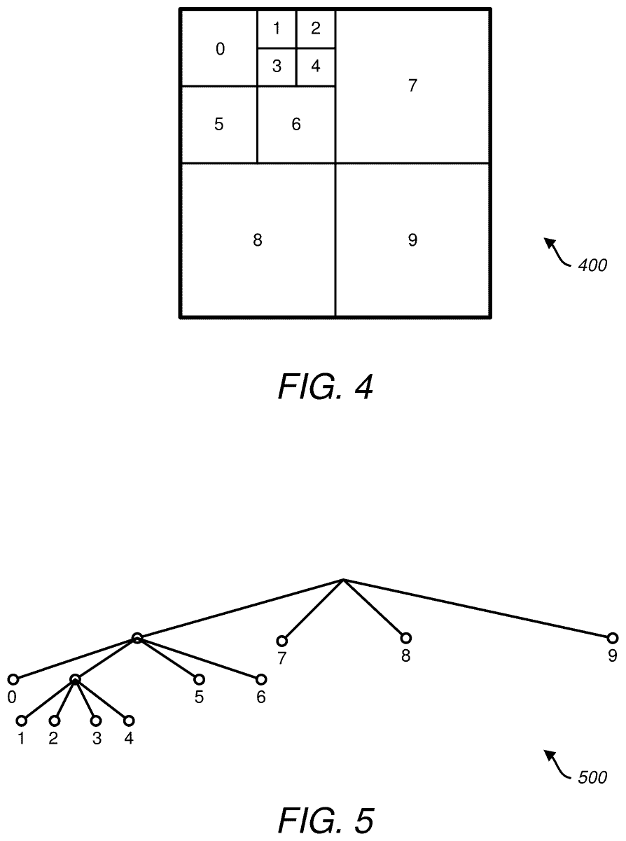

FIG. 4 illustrates an example quadtree partitioning of a CTB 400. FIG. 5 illustrates a corresponding quadtree 500 of the example quadtree partitioning of CTB 400 in FIG. 4. As shown in FIGS. 4 and 5, CTB 400 is first partitioned into four CBs of half vertical and half horizontal size. Three of the resulting CBs of the first level partitioning of CTB 400 are leaf-CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

Altogether, CTB 400 is partitioned into 10 leaf CBs respectively labeled 0-9. The resulting quadtree partitioning of CTB 400 may be scanned using a z-scan (left-to-right, top-to-bottom) to form the sequence order for encoding/decoding the CB leaf nodes. The numeric label of each CB leaf node in FIGS. 4 and 5 may correspond to the sequence order for encoding/decoding, with CB leaf node 0 encoded/decoded first and CB leaf node 9 encoded/decoded last. Although not shown in FIGS. 4 and 5, it should be noted that each CB leaf node may comprise one or more PBs and TBs.

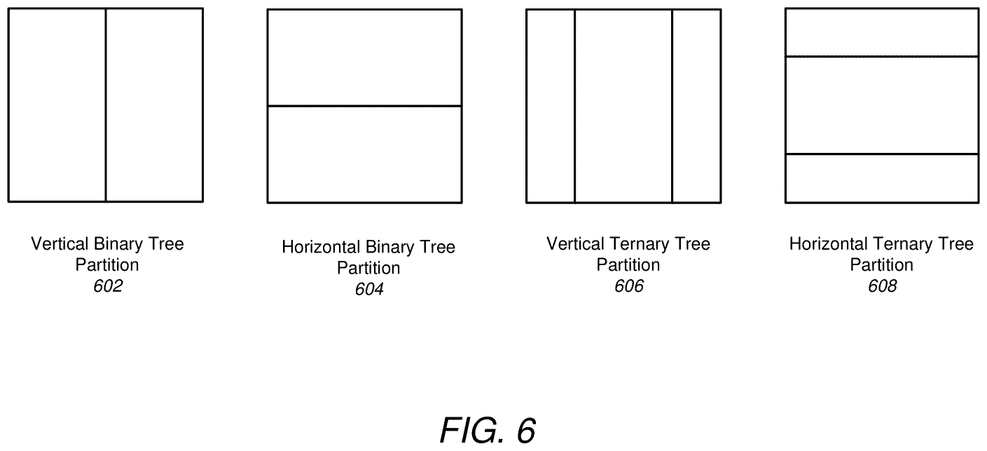

In VVC, a picture may be partitioned in a similar manner as in HEVC. A picture may be first partitioned into non-overlapping square CTBs. The CTBs may then be partitioned by a recursive quadtree partitioning into CBs of half vertical and half horizontal size. In VVC, a quadtree leaf node may be further partitioned by a binary tree or ternary tree partitioning into CBs of unequal sizes. FIG. 6 illustrates example binary and ternary tree partitions. A binary tree partition may divide a parent block in half in either the vertical direction 602 or horizontal direction 604. The resulting partitions may be half in size as compared to the parent block. A ternary tree partition may divide a parent block into three parts in either the vertical direction 606 or horizontal direction 608. The middle partition may be twice as large as the other two end partitions in a ternary tree partition.

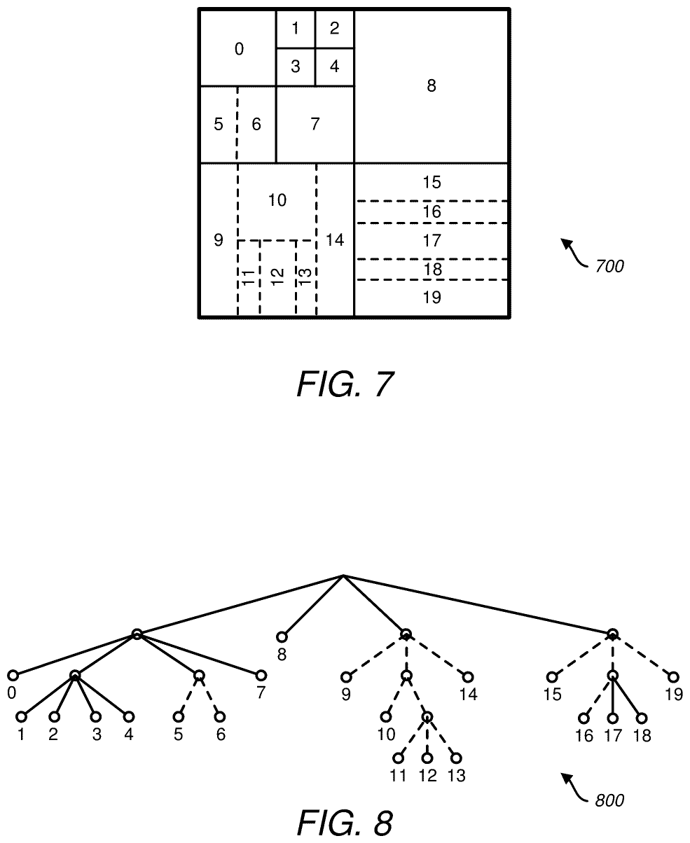

Because of the addition of binary and ternary tree partitioning, in VVC the block partitioning strategy may be referred to as quadtree+multi-type tree partitioning. FIG. 7 illustrates an example quadtree+multi-type tree partitioning of a CTB 700. FIG. 8 illustrates a corresponding quadtree+multi-type tree 800 of the example quadtree+multi-type tree partitioning of CTB 700 in FIG. 7. In both FIGS. 7 and 8, quadtree splits are shown in solid lines and multi-type tree splits are shown in dashed lines. For ease of explanation, CTB 700 is shown with the same quadtree partitioning as CTB 400 described in FIG. 4. Therefore, description of the quadtree partitioning of CTB 700 is omitted. The description of the additional multi-type tree partitions of CTB 700 is made relative to three leaf-CBs shown in FIG. 4 that have been further partitioned using one or more binary and ternary tree partitions. The three leaf-CBs in FIG. 4 that are shown in FIG. 7 as being further partitioned are leaf-CBs 5, 8, and 9.

Starting with leaf-CB 5 in FIG. 4, FIG. 7 shows this leaf-CB partitioned into two CBs based on a vertical binary tree partitioning. The two resulting CBs are leaf-CBs respectively labeled 5 and 6 in FIGS. 7 and 8. With respect to leaf-CB 8 in FIG. 4, FIG. 7 shows this leaf-CB partitioned into three CBs based on a vertical ternary tree partition. Two of the three resulting CBs are leaf-CBs respectively labeled 9 and 14 in FIGS. 7 and 8. The remaining, non-leaf CB is partitioned first into two CBs based on a horizontal binary tree partition, one of which is a leaf-CB labeled 10 and the other of which is further partitioned into three CBs based on a vertical ternary tree partition. The resulting three CBs are leaf-CBs respectively labeled 11, 12, and 13 in FIGS. 7 and 8. Finally, with respect to leaf-CB 9 in FIG. 4, FIG. 7 shows this leaf-CB partitioned into three CBs based on a horizontal ternary tree partition. Two of the three CBs are leaf-CBs respectively labeled 15 and 19 in FIGS. 7 and 8. The remaining, non-leaf CB is partitioned into three CBs based on another horizontal ternary tree partition. The resulting three CBs are all leaf-CBs respectively labeled 16, 17, and 18 in FIGS. 7 and 8.

Altogether, CTB 700 is partitioned into 20 leaf CBs respectively labeled 0-19. The resulting quadtree+multi-type tree partitioning of CTB 700 may be scanned using a z-scan (left-to-right, top-to-bottom) to form the sequence order for encoding/decoding the CB leaf nodes. The numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and TBs.

In addition to specifying various blocks (e.g., CTB, CB, PB, TB), HEVC and WC further define various units. While blocks may comprise a rectangular area of samples in a sample array, units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bit stream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

It should be noted that the term block may be used to refer to any of a CTB, CB, PB, TB, CTU, CU, PU, or TU in the context of HEVC and VVC. It should be further noted that the term block may be used to refer to similar data structures in the context of other video coding standards. For example, the term block may refer to a macroblock in AVC, a macroblock or sub-block in VP8, a superblock or sub-block in VP9, or a superblock or sub-block in AV1.

In intra prediction, samples of a block to be encoded (also referred to as the current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted by projecting the position of the sample in the current block in a given direction (also referred to as an intra prediction mode) to a point along the reference samples. The sample may be predicted by interpolating between the two closest reference samples of the projection point if the projection does not fall directly on a reference sample. A prediction error (also referred to as a residual) may be determined for the current block based on differences between the predicted sample values and the original sample values of the current block.

At an encoder, this process of predicting samples and determining a prediction error based on a difference between the predicted samples and original samples may be performed for a plurality of different intra prediction modes, including non-directional intra prediction modes. The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block using the intra prediction mode indicated by the encoder and combining the predicted samples with the prediction error.

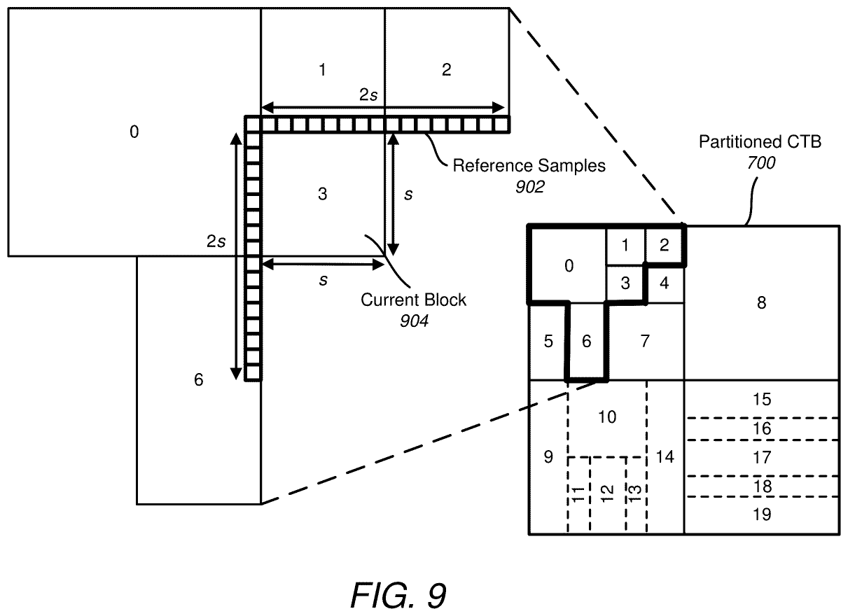

FIG. 9 illustrates an example set of reference samples 902 determined for intra prediction of a current block 904 being encoded or decoded. In FIG. 9, current block 904 corresponds to block 3 of partitioned CTB 700 in FIG. 7. As explained above, the numeric labels 0-19 of the blocks of partitioned CTB 700 may correspond to the sequence order for encoding/decoding the blocks and are used as such in the example of FIG. 9.

Given current block 904 is of w×h samples in size, reference samples 902 may extend over 2w samples of the row immediately adjacent to the top-most row of current block 904, 2h samples of the column immediately adjacent to the left-most column of current block 904, and the top left neighboring corner sample to current block 904. In the example of FIG. 9, current block 904 is square, so w=h=s. For constructing the set of reference samples 902, available samples from neighboring blocks of current block 904 may be used. Samples may not be available for constructing the set of reference samples 902 if, for example, the samples would lie outside the picture of the current block, the samples are part of a different slice of the current block (where the concept of slices are used), and/or the samples belong to blocks that have been inter coded and constrained intra prediction is indicated. When constrained intra prediction is indicated, intra prediction may not be dependent on inter predicted blocks.

In addition to the above, samples that may not be available for constructing the set of reference samples 902 include samples in blocks that have not already been encoded and reconstructed at an encoder or decoded at a decoder based on the sequence order for encoding/decoding. This restriction may allow identical prediction results to be determined at both the encoder and decoder. In FIG. 9, samples from neighboring blocks 0, 1, and 2 may be available to construct reference samples 902 given that these blocks are encoded and reconstructed at an encoder and decoded at a decoder prior to coding of current block 904. This assumes there are no other issues, such as those mentioned above, preventing the availability of samples from neighboring blocks 0, 1, and 2. However, the portion of reference samples 902 from neighboring block 6 may not be available due to the sequence order for encoding/decoding.

Unavailable ones of reference samples 902 may be filled with available ones of reference samples 902. For example, an unavailable reference sample may be filled with a nearest available reference sample determined by moving in a clock-wise direction through reference samples 902 from the position of the unavailable reference. If no reference samples are available, reference samples 902 may be filled with the mid-value of the dynamic range of the picture being coded.

It should be noted that reference samples 902 may be filtered based on the size of current block 904 being coded and an applied intra prediction mode. It should be further noted that FIG. 9 illustrates only one exemplary determination of reference samples for intra prediction of a block. In some proprietary and industry video coding standards, reference samples may be determined in a different manner than discussed above. For example, multiple reference lines may be used in other instances, such as used in VVC.

After reference samples 902 are determined and optionally filtered, samples of current block 904 may be intra predicted based on reference samples 902. Most encoders/decoders support a plurality of intra prediction modes in accordance with one or more video coding standards. For example, HEVC supports 35 intra prediction modes, including a planar mode, a DC mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture.

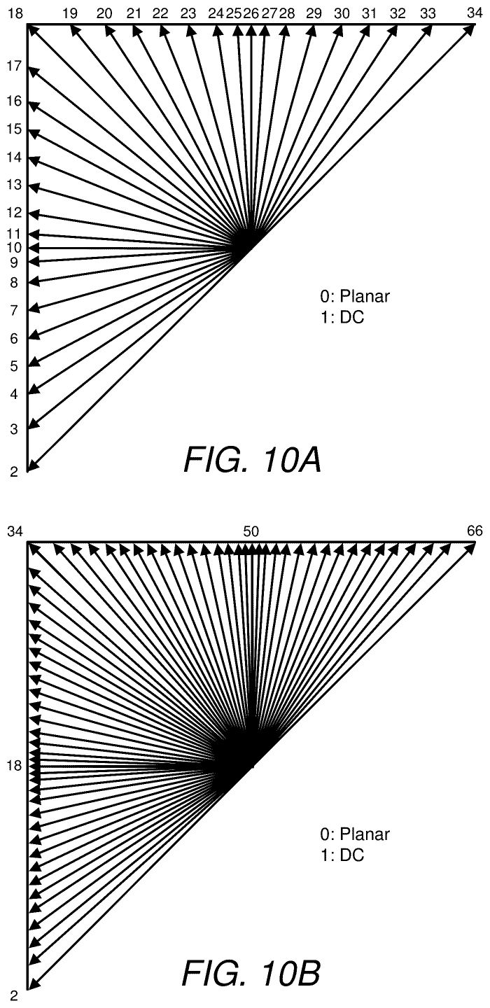

FIG. 10A illustrates the 35 intra prediction modes supported by HEVC. The 35 intra prediction modes are identified by indices 0 to 34. Prediction mode 0 corresponds to planar mode. Prediction mode 1 corresponds to DC mode. Prediction modes 2-34 correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B illustrates the 67 intra prediction modes supported by VVC. The 67 intra prediction modes are identified by indices 0 to 66. Prediction mode 0 corresponds to planar mode. Prediction mode 1 corresponds to DC mode. Prediction modes 2-66 correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Because blocks in VVC may be non-square, some of the intra prediction modes illustrated in FIG. 10B may be adaptively replaced by wide-angle directions.

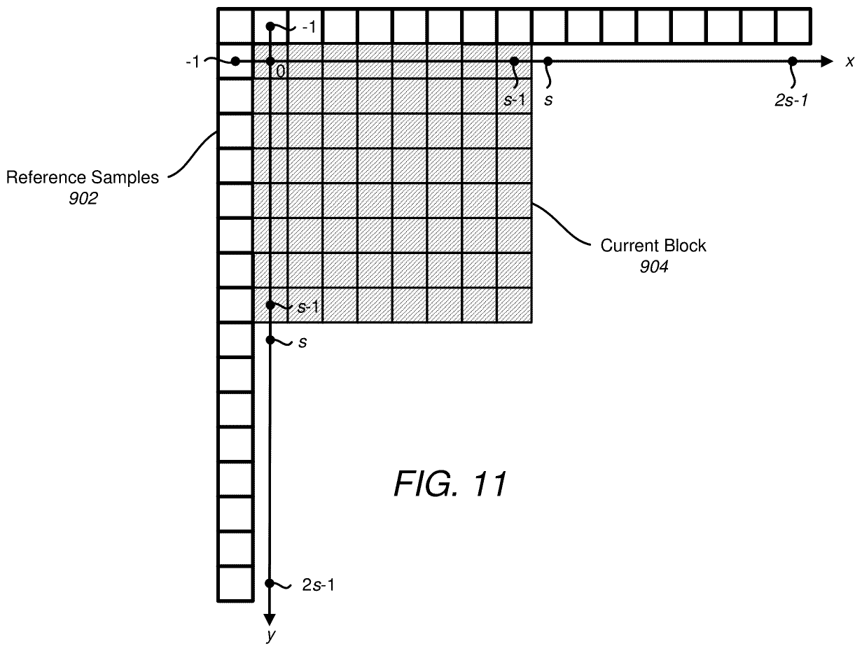

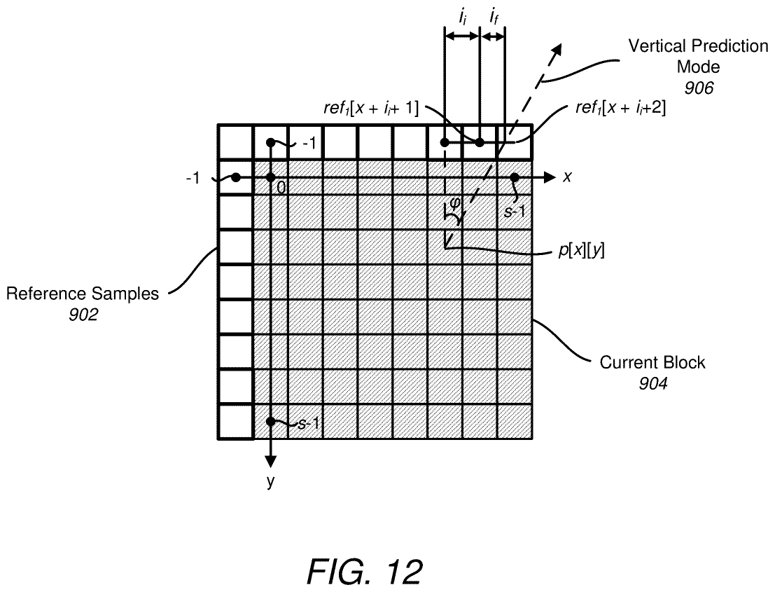

To further describe the application of intra prediction modes to determine a prediction of a current block, reference is made to FIGS. 11 and 12. In FIG. 11, current block 904 and reference samples 902 from FIG. 9 are shown in a two-dimensional x, y plane, where a sample may be referenced as p[x][y]. In order to simplify the prediction process, reference samples 902 may be placed in two, one-dimensional arrays. Reference samples 902 above current block 904 may be placed in the one-dimensional array ref₁[x]:

$$r e {f}_{1} [ x ] = p [ - 1 + x ] [ - 1 ] , ( x \geq 0 ) \qquad ( 1 )$$

Reference samples 902 to the left of current block 904 may be placed in the one-dimensional array ref₂[x]:

$$r e {f}_{2} ⌈ y ] = p [ - 1 ] [ - 1 + y ] , ( y \geq 0 ) \qquad ( 2 )$$

For planar mode, a sample at location [x][y] in current block 904 may be predicted by calculating the mean of two interpolated values. The first of the two interpolated values may be based on a horizontal linear interpolation at location [x][y] in current block 904. The second of the two interpolated values may be based on a vertical linear interpolation at location [x][y] in current block 904. The predicted sample p[x][y] in current block 904 may be calculated as

$$p [ x ] [ y ] = \frac{1}{2 \cdot s} ( h [ x ] [ y ] + v [ x ] [ y ] + s ) \qquad ( 3 )$$

where

$$h [ x ] [ y ] = ( s - x - 1 ) \cdot {ref}_{2} [ y ] + ( x + 1 ) \cdot {ref}_{1} [ s ] \qquad ( 4 )$$

may be the horizonal linear interpolation at location [x][y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at location [x][y] in current block 904.

For DC mode, a sample at location [x][y] in current block 904 may be predicted by the mean of the reference samples 902. The predicted value sample p[x][y] in current block 904 may be calculated as

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) \qquad ( 6 )$$

For angular modes, a sample at location [x][y] in current block 904 may be predicted by projecting the location [x][y] in a direction specified by a given angular mode to a point on the horizontal or vertical line of samples comprising reference samples 902. The sample at location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC) and relative to the x-axis for horizontal prediction modes (e.g., modes 2-18 in HEVC and modes 2-34 in VVC).

FIG. 12 illustrates a prediction of a sample at location [x][y] in current block 904 for a vertical prediction mode 906 given by an angle φ. For vertical prediction modes, the location [x][y] in current block 904 is projected to a point (referred to herein as the “projection point”) on the horizontal line of reference samples ref₁[x]. Reference samples 902 are only partially shown in FIG. 12 for ease of illustration. Because the projection point falls at a fractional sample position between two reference samples in the example of FIG. 12, the predicted sample p[x][y] in current block 904 may be calculated by linearly interpolating between the two reference samples as follows

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] \qquad ( 7 )$$

where iᵢ is the integer part of the horizontal displacement of the projection point relative to the location [x][y] and may calculated as a function of the tangent of the angle φ of the vertical prediction mode 906 as follows

$${i}_{i} = ⌊ ( y + 1 ) \cdot tan φ ⌋ , \qquad ( 8 )$$

and i_{f} is the fractional part of the horizontal displacement of the projection point relative to the location [x][y] and may be calculated as

$${i}_{f} = ( ( y + 1 ) \cdot tan φ ) - ⌊ ( y + 1 ) \cdot tan φ ⌋ . \qquad ( 9 )$$

where └⋅┘ is the integer floor.

For horizontal prediction modes, the position [x][y] of a sample in current block 904 may be projected onto the vertical line of reference samples ref₂[y]. Sample prediction for horizontal prediction modes is given by:

$$p [ x ] [ y ] = ( 1 - {i}_{f} ) \cdot {ref}_{2} [ y + {i}_{i} + 1 ] + {i}_{f} \cdot {ref}_{2} [ y + {i}_{i} + 2 ] \qquad ( 10 )$$

where iᵢ is the integer part of the vertical displacement of the projection point relative to the location [x][y] and may be calculated as a function of the tangent of the angle cp of the horizontal prediction mode as follows

$${i}_{i} = ⌊ ( x + 1 ) \cdot tan φ ⌋ , \qquad ( 11 )$$

and i_{f} is the fractional part of the vertical displacement of the projection point relative to the location [x][y] and may be calculated as

$${i}_{f} = ( ( x + 1 ) \cdot tan φ ) - ⌊ ( x + 1 ) \cdot tan φ ⌋ . \qquad ( 12 )$$

where └⋅┘ is the integer floor.

The interpolation functions of (7) and (10) may be implemented by an encoder or decoder, such as encoder 200 in FIG. 2 or decoder 300 in FIG. 3, as a set of two-tap finite impulse response (FIR) filters. The coefficients of the two-tap FIR filters may be respectively given by (1−i_{f}) and i_{f}. In the above angular intra prediction examples, the predicted sample p[x][y] may be calculated with some predefined level of sample accuracy, such as 1/32 sample accuracy. For 1/32 sample accuracy, the set of two-tap FIR interpolation filters may comprise up to 32 different two-tap FIR interpolation filters—one for each of the 32 possible values of the fractional part of the projected displacement i_{f}. In other examples, different levels of sample accuracy may be used.

In an embodiment, the two-tap interpolation FIR filter may be used for predicting chroma samples. For luma samples, a different interpolation technique may be used. For example, for luma samples a four-tap FIR filter may be used to determine a predicted value of a luma sample. For example, the four tap FIR filter may have coefficients determined based on i_{f}, similar to the two-tap FIR filter. For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on i_{f}. The value of the predicted sample p[x][y], for vertical prediction modes, may be determined based on the four-tap FIR filter as follows:

$$p [ x ] [ y ] = {\sum }_{i = 0}^{3} fT [ i ] * ref [ x + iIdx + i ] \qquad ( 13 )$$

where fT[i], i=0 . . . 3, are the filter coefficients. The value of the predicted sample p[x][y], for horizontal prediction modes, may be determined based on the four-tap FIR filter as follows:

$$p [ x ] [ y ] = {\sum }_{i = 0}^{3} fT [ i ] * ref [ y + iIdx + i ] . \qquad ( 14 )$$

It should be noted that supplementary reference samples may be constructed for the case where the position [x][y] of a sample in current block 904 to be predicted is projected to a negative x coordinate, which happens with negative vertical prediction angles φ. The supplementary reference samples may be constructed by projecting the reference samples in ref₂[y] in the vertical line of reference samples 902 to the horizontal line of reference samples 902 using the negative vertical prediction angle φ. Supplemental reference samples may be similarly for the case where the position [x][y] of a sample in current block 904 to be predicted is projected to a negative y coordinate, which happens with negative horizontal prediction angles φ. The supplementary reference samples may be constructed by projecting the reference samples in ref₁[x] on the horizontal line of reference samples 902 to the vertical line of reference samples 902 using the negative horizontal prediction angle φ.

An encoder may predict the samples of a current block being encoded, such as current block 904, for a plurality of intra prediction modes as explained above. For example, the encoder may predict the samples of the current block for each of the 35 intra prediction modes in HEVC or 67 intra prediction modes in VVC. For each intra prediction mode applied, the encoder may determine a prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may select one of the intra prediction modes to encode the current block based on the determined prediction errors. For example, the encoder may select an intra prediction mode that results in the smallest prediction error for the current block. In another example, the encoder may select the intra prediction mode to encode the current block based on a rate-distortion measure (e.g., Lagrangian rate-distortion cost) determined using the prediction errors. The encoder may send an indication of the selected intra prediction mode and its corresponding prediction error to a decoder for decoding of the current block.

Similar to an encoder, a decoder may predict the samples of a current block being decoded, such as current block 904, for an intra prediction mode as explained above. For example, the decoder may receive an indication of an angular intra prediction mode from an encoder for a block. The decoder may construct a set of reference samples and perform intra prediction based on the angular intra prediction mode indicated by the encoder for the block in a similar manner as discussed above for the encoder. The decoder would add the predicted values of the samples of the block to a residual of the block to reconstruct the block. In another embodiment, the decoder may not receive an indication of an angular intra prediction mode from an encoder for a block. Instead, the decoder may determine an intra prediction mode through other, decoder-side means.

Although the description above was primarily made with respect to intra prediction modes in HEVC and VVC, it will be understood that the techniques of the present disclosure described above and further below may be applied to other intra prediction modes, including those of other video coding standards like VP8, VP9, AV1, and the like.

As explained above, intra prediction may exploit correlations between spatially neighboring samples in the same picture of a video sequence to perform video compression. Inter prediction is another coding tool that may be used to exploit correlations in the time domain between blocks of samples in different pictures of the video sequence to perform video compression. In general, an object may be seen across multiple pictures of a video sequence. The object may move (e.g., by some translation and/or affine motion) or remain stationary across the multiple pictures. A current block of samples in a current picture being encoded may therefore have a corresponding block of samples in a previously decoded picture that accurately predicts the current block of samples. The corresponding block of samples may be displaced from the current block of samples due to movement of an object, represented in both blocks, across the respective pictures of the blocks. The previously decoded picture may be referred to as a reference picture and the corresponding block of samples in the reference picture may be referred to as a reference block or motion compensated prediction. An encoder may use a block matching technique to estimate the displacement (or motion) and determine the reference block in the reference picture.

Similar to intra prediction, once a prediction for a current block is determined and/or generated using inter prediction, an encoder may determine a difference between the current block and the prediction. The difference may be referred to as a prediction error or residual. The encoder may then store and/or signal in a bitstream the prediction error and other related prediction information for decoding or other forms of consumption. A decoder may decode the current block by predicting the samples of the current block using the prediction information and combining the predicted samples with the prediction error.

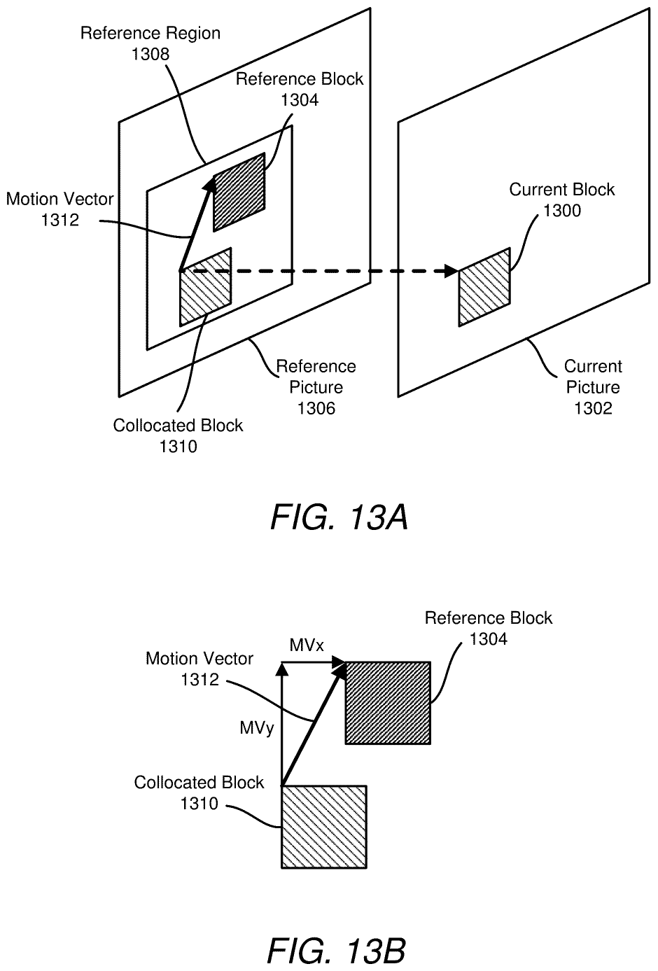

FIG. 13A illustrates an example of inter prediction performed for a current block 1300 in a current picture 1302 being encoded. An encoder, such as encoder 200 in FIG. 2, may perform inter prediction to determine and/or generate a reference block 1304 in a reference picture 1306 to predict current block 1300. Reference pictures, like reference picture 1306, are prior decoded pictures available at the encoder and decoder. Availability of a prior decoded picture may depend on whether the prior decoded picture is available in a decoded picture buffer at the time current block 1300 is being encoded or decoded. The encoder may, for example, search one or more reference pictures for a reference block that is similar to current block 1300. The encoder may determine a “best matching” reference block from the blocks tested during the searching process as reference block 1304. The encoder may determine that reference block 1304 is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction samples of reference block 1304 and the original samples of current block 1300.

The encoder may search for reference block 1304 within a search range 1308. Search range 1308 may be positioned around the collocated position (or block) 1310 of current block 1300 in reference picture 1306. In some instances, search range 1308 may at least partially extend outside of reference picture 1306. When extending outside of reference picture 1306, constant boundary extension may be used such that the values of the samples in the row or column of reference picture 1306, immediately adjacent to the portion of search range 1308 extending outside of reference picture 1306, are used for the “sample” locations outside of reference picture 1306. All or a subset of potential positions within search range 1308 may be searched for reference block 1304. The encoder may utilize any one of a number of different search implementations to determine and/or generate reference block 1304. For example, the encoder may determine a set of a candidate search positions based on motion information of neighboring blocks to current block 1300.

One or more reference pictures may be searched by the encoder during inter prediction to determine and/or generate the best matching reference block. The reference pictures searched by the encoder may be included in one or more reference picture lists. For example, in HEVC and VVC, two reference picture lists may be used, a reference picture list 0 and a reference picture list 1. A reference picture list may include one or more pictures. Reference picture 1306 of reference block 1304 may be indicated by a reference index pointing into a reference picture list comprising reference picture 1306.

The displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. FIG. 13B illustrates the horizontal component and vertical component of motion vector 1312. A motion vector, such as motion vector 1312, may have fractional or integer resolution. A motion vector with fractional resolution may point between two samples in a reference picture to provide a better estimation of the motion of current block 1300. For example, a motion vector may have ½, ¼, ⅛, 1/16, or 1/32 fractional sample resolution. When a motion vector points to a non-integer sample value in the reference picture, interpolation between samples at integer positions may be used to generate the reference block and its corresponding samples at fractional positions. The interpolation may be performed by a filter with two or more taps.

Once reference block 1304 is determined and/or generated for current block 1300 using inter prediction, the encoder may determine a difference (e.g., a corresponding sample-by-sample difference) between reference block 1304 and current block 1300. The difference may be referred to as a prediction error or residual. The encoder may then store and/or signal in a bitstream the prediction error and the related motion information for decoding or other forms of consumption. The motion information may include motion vector 1312 and a reference index pointing into a reference picture list comprising reference picture 1306. In other instances, the motion information may include an indication of motion vector 1312 and an indication of the reference index pointing into the reference picture list comprising reference picture 1306. A decoder may decode current block 1300 by determining and/or generating reference block 1304, which forms the prediction of current block 1300, using the motion information and combining the prediction with the prediction error.

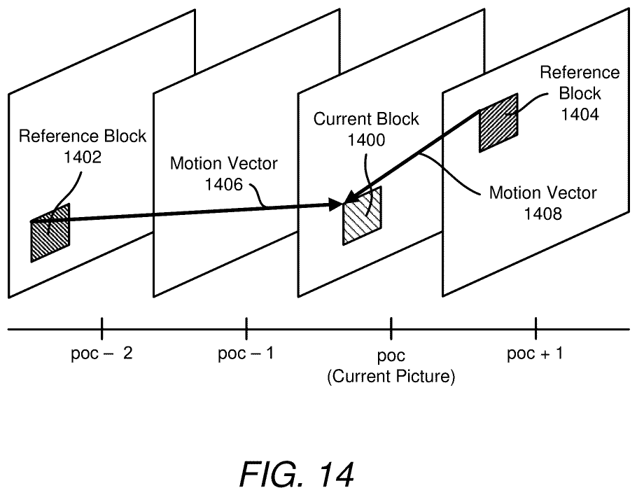

In FIG. 13A, inter prediction is performed using one reference picture 1306 as the source of the prediction for current block 1300. Because the prediction for current block 1300 comes from a single picture, this type of inter prediction is referred to as uni-prediction. FIG. 14 illustrates another type of inter prediction, referred to as bi-prediction, performed for a current block 1400. In bi-prediction, the source of the prediction for a current block 1400 comes from two pictures. Bi-prediction may be useful, for example, where the video sequence comprises fast motion, camera panning or zooming, or scene changes. Bi-prediction may also be useful to capture fade outs of one scene or fade outs from one scene to another, where two pictures are effectively displayed simultaneously with different levels of intensity.

Whether uni-prediction or both uni-prediction and bi-prediction are available for performing inter prediction may depend on a slice type of current block 1400. For P slices, only uni-prediction may be available for performing inter prediction. For B slices, either uni-prediction or bi-prediction may be used. When uni-prediction is performed, an encoder may determine and/or generate a reference block for predicting current block 1400 from reference picture list 0. When bi-prediction is performed, an encoder may determine and/or generate a first reference block for predicting current block 1400 from reference picture list 0 and determine and/or generate a second reference block for predicting current block 1400 from reference picture list 1.

In FIG. 14, inter-prediction is performed using bi-prediction, where two reference blocks 1402 and 1404 are used to predict current block 1400. Reference block 1402 may be in a reference picture of one of reference picture list 0 or 1, and reference block 1404 may be in a reference picture of the other one of reference picture list 0 or 1. As shown in FIG. 14, reference block 1402 is in a picture that precedes the current picture of current block 1400 in terms of picture order count (POC), and reference block 1402 is in a picture that proceeds the current picture of current block 1400 in terms of POC. In other examples, the reference pictures may both precede or proceed the current picture in terms of POC. POC is the order in which pictures are output from, for example, a decoded picture buffer and is the order in which pictures are generally intended to be displayed. However, it should be noted that pictures that are output are not necessarily displayed but may undergo different processing or consumption, such as transcoding. In other examples, the two reference blocks determined and/or generated using bi-prediction may come from the same reference picture. In such an instance, the reference picture may be included in both reference picture list 0 and reference picture list 1.

A configurable weight and offset value may be applied to the one or more inter prediction reference blocks. An encoder may enable the use of weighted prediction using a flag in a picture parameter set (PPS) and signal the weighting and offset parameters in the slice segment header for the current block. Different weight and offset parameters may be signaled for luma and chroma components.

Once reference blocks 1402 and 1404 are determined and/or generated for current block 1400 using inter prediction, the encoder may determine a difference between current block 1400 and each of reference blocks 1402 and 1404. The differences may be referred to as prediction errors or residuals. The encoder may then store and/or signal in a bitstream the prediction errors and their respective related motion information for decoding or other forms of consumption. The motion information for reference block 1402 may include motion vector 1406 and the reference index pointing into the reference picture list comprising the reference picture of reference block 1402. In other instances, the motion information for reference block 1402 may include an indication of motion vector 1406 and an indication of the reference index pointing into the reference picture list comprising a reference picture including reference block 1402. The motion information for reference block 1404 may include motion vector 1408 and the reference index pointing into the reference picture list comprising the reference picture of reference block 1404. In other instances, the motion information for reference block 1404 may include an indication of motion vector 1408 and an indication of the reference index pointing into the reference picture list comprising the reference picture of reference block 1404. A decoder may decode current block 1400 by determining and/or generating reference blocks 1402 and 1404, which together form the prediction of current block 1400, using their respective motion information and combining the predictions with the prediction errors.

In HEVC, VVC, and other video compression schemes, motion information may be predictively coded before being stored or signaled in a bit stream. The motion information for a current block may be predictively coded based on the motion information of neighboring blocks of the current block. In general, the motion information of the neighboring blocks is often correlated with the motion information of the current block because the motion of an object represented in the current block is often the same or similar to the motion of objects in the neighboring blocks. Two of the motion information prediction techniques in HEVC and VVC include advanced motion vector prediction (AMVP) and inter prediction block merging.

An encoder, such as encoder 200 in FIG. 2, may code a motion vector using the AMVP tool as a difference between the motion vector of a current block being coded and a motion vector predictor (MVP). An encoder may select the MVP from a list of candidate MVPs. The candidate MVPs may come from previously decoded motion vectors of neighboring blocks in the current picture of the current block or blocks at or near the collocated position of the current block in other reference pictures. Both the encoder and decoder may generate or determine the list of candidate MVPs.

After the encoder selects an MVP from the list of candidate MVPs, the encoder may signal, in a bitstream, an indication of the selected MVP and a motion vector difference (MVD). The encoder may indicate the selected MVP in the bitstream by an index pointing into the list of candidate MVPs. The MVD may be calculated based on the difference between the motion vector of the current block and the selected MVP. In other words, the MVD indicates a displacement from the selected MVP to a position of the current block (e.g., a co-located position in the reference picture for the current block). For example, for a motion vector represented by a horizontal component (MVx) and a vertical displacement (MVy) relative to the position of the current block being coded, the MVD may be represented by two components calculated as follows:

$$M V {D}_{x} = M {V}_{x} - M V {P}_{x} \qquad ( 15 )$$

$$M V {D}_{y} = M {V}_{y} - M V {P}_{y} \qquad ( 16 )$$

where MVDₓ and MVD_{y} respectively represent the horizontal and vertical components of the MVD, and MVPₓ and MVP_{y} respectively represent the horizontal and vertical components of the MVP. A decoder, such as decoder 300 in FIG. 3, may decode the motion vector by adding the MVD to the MVP indicated in the bitstream. The decoder may then decode the current block by determining and/or generating the reference block, which forms the prediction of the current block, using the decoded motion vector and combining the prediction with the prediction error.

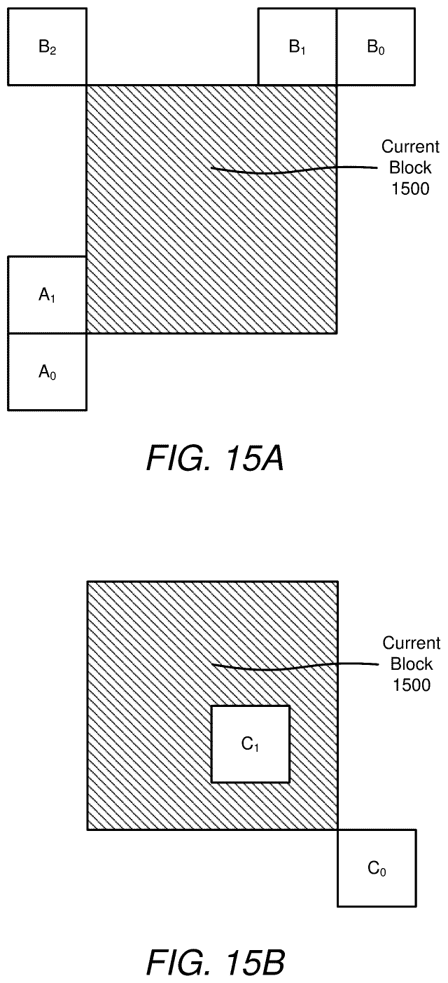

In HEVC and VVC, the list of candidate MVPs for AMVP may comprise two candidates referred to as candidates A and B. Candidates A and B may include up to two spatial candidate MVPs derived from five spatial neighboring blocks of the current block being coded, one temporal candidate MVP derived from two temporal, co-located blocks when both spatial candidate MVPs are not available or are identical, or zero motion vectors when the spatial, temporal, or both candidates are not available. FIG. 15A illustrates the location of the five spatial candidate neighboring blocks relative to a current block 1500 being encoded. The five spatial candidate neighboring blocks are respectively denoted A₀, A₁, B₀, B₁, and B₂. FIG. 15B illustrates the location of the two temporal, co-located blocks relative to current block 1500 being coded. The two temporal, co-located blocks are denoted C₀ and C₁ and are included in a reference picture that is different from the current picture of current block 1500.

An encoder, such as encoder 200 in FIG. 2, may code a motion vector using the inter prediction block merging tool also referred to as merge mode. Using merge mode, the encoder may reuse the same motion information of a neighboring block for inter prediction of a current block. Because the same motion information of a neighboring block is used, no MVD needs to be signaled and the signaling overhead for signaling the motion information of the current block may be small in size. Similar to AMVP, both the encoder and decoder may generate a candidate list of motion information from neighboring blocks of the current block. The encoder may then determine to use (or inherit) the motion information of one neighboring block's motion information in the candidate list for predicting the motion information of the current block being coded. The encoder may signal, in the bit stream, an indication of the determined motion information from the candidate list. For example, the encoder may signal an index pointing into the list of candidate motion information to indicate the determined motion information.

In HEVC and VVC, the list of candidate motion information for merge mode may comprise up to four spatial merge candidates that are derived from the five spatial neighboring blocks used in AMVP as shown in FIG. 15A, one temporal merge candidate derived from two temporal, co-located blocks used in AMVP as shown in FIG. 15B, and additional merge candidates including bi-predictive candidates and zero motion vector candidates.

It should be noted that inter prediction may be performed in other ways and variants than those described above. For example, motion information prediction techniques other than AMVP and merge mode are possible. In addition, although the description above was primarily made with respect to inter prediction modes in HEVC and VVC, it will be understood that the techniques of the present disclosure described above and further below may be applied to other inter prediction modes, including those of other video coding standards like VP8, VP9, AV1, and the like. In addition, history based motion vector prediction (HMVP), combined intra/inter prediction mode (CIIP), and merge mode with motion vector difference (MMVD) as described in VVC may also be performed and are within the scope of the present disclosure.

In inter prediction, a block matching technique may be applied to determine a reference block in a different picture than the current block being encoded. Block matching techniques have also been applied to determine a reference block in the same picture as a current block being encoded. However, it has been determined that for camera-captured videos, a reference block in the same picture as the current block determined using block matching may often not accurately predict the current block. For screen content video this is generally not the case. Screen content video may include, for example, computer generated text, graphics, and animation. Within screen content, there is often repeated patterns (e.g., repeated patterns of text and graphics) within the same picture. Therefore, a block matching technique applied to determine a reference block in the same picture as a current block being encoded may provide efficient compression for screen content video.

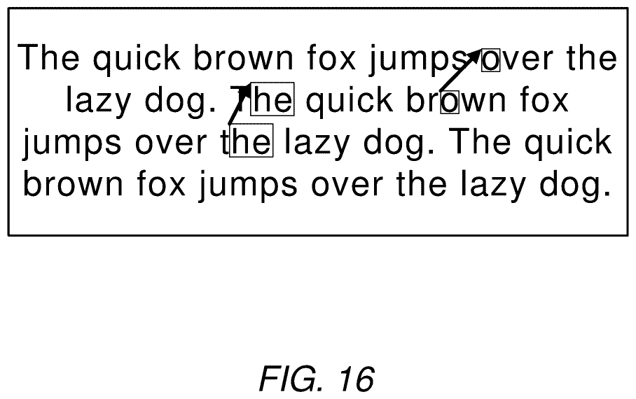

HEVC and VVC both include a prediction technique to exploit the correlation between blocks of samples within the same picture of screen content video. This technique is referred to as intra block copy (IBC) or current picture referencing (CPR). Similar to inter prediction, an encoder may apply a block matching technique to determine a displacement vector (referred to as a block vector (BV)) that indicates the relative displacement from the current block to a reference block (or intra block compensated prediction) that “best matches” the current block. The encoder may determine the best matching reference block from blocks tested during a searching process similar to inter prediction. The encoder may determine that a reference block is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the prediction samples of the reference block and the original samples of the current block. A reference block may correspond to prior decoded blocks of samples of the current picture. The reference block may comprise decoded blocks of samples of the current picture prior to being processed by in-loop filtering operations, like deblocking or SAO filtering. FIG. 16 illustrates an example of IBC applied for screen content. The rectangular portions with arrows beginning at their boundaries are current blocks being encoded and the rectangular portions that the arrows point to are the reference blocks for predicting the current blocks.

Once a reference block is determined and/or generated for a current block using IBC, the encoder may determine a difference (e.g., a corresponding sample-by-sample difference) between the reference block and the current block. The difference may be referred to as a prediction error or residual. The encoder may then store and/or signal in a bitstream the prediction error and the related prediction information for decoding or other forms of consumption. The prediction information may include a BV. In other instances, the prediction information may include an indication of the BV. A decoder, such as decoder 300 in FIG. 3, may decode the current block by determining and/or generating the reference block, which forms the prediction of the current block, using the prediction information and combining the prediction with the prediction error.

In HEVC, VVC, and other video compression schemes, a BV may be predictively coded before being stored or signaled in a bit stream. The BV for a current block may be predictively coded based on the BV of neighboring blocks of the current block. For example, an encoder may predictively code a BV using the merge mode as explained above for inter prediction or a similar technique as AMVP also explained above for inter prediction. The technique similar to AMVP may be referred to as BV prediction and difference coding.

For BV prediction and difference coding, an encoder, such as encoder 200 in FIG. 2, may code a BV as a difference between the BV of a current block being coded and a BV predictor (BVP). An encoder may select the BVP from a list of candidate BVPs. The candidate BVPs may come from previously decoded BVs of neighboring blocks of the current block in the current picture. Both the encoder and decoder may generate or determine the list of candidate BVPs.

After the encoder selects a BVP from the list of candidate BVPs, the encoder may signal, in a bitstream, an indication of the selected BVP and a BV difference (BVD). The encoder may indicate the selected BVP in the bitstream by an index pointing into the list of candidate BVPs. The BVD may be calculated based on the difference between the BV of the current block and the selected BVP. For example, for a BV represented by a horizontal component (BVₓ) and a vertical component (BV_{y}) relative to the position of the current block being coded, the BVD may represented by two components calculated as follows:

$$B V {D}_{x} = B {V}_{x} - B V {P}_{x} \qquad ( 17 )$$

$$B V {D}_{y} = B {V}_{y} - B V {P}_{y} \qquad ( 18 )$$

where BVDₓ and BVD_{y} respectively represent the horizontal and vertical components of the BVD, and BVPₓ and BVP_{y} respectively represent the horizontal and vertical components of the BVP. A decoder, such as decoder 300 in FIG. 3, may decode the BV by adding the BVD to the BVP indicated in the bitstream. The decoder may then decode the current block by determining and/or generating the reference block, which forms the prediction of the current block, using the decoded BV and combining the prediction with the prediction error.

In HEVC and VVC, the list of candidate BVPs may comprise two candidates referred to as candidates A and B. Candidates A and B may include up to two spatial candidate BVPs derived from five spatial neighboring blocks of the current block being encoded, or one or more of the last two coded BVs when spatial neighboring candidates are not available (e.g., because they are coded in intra or inter mode). The location of the five spatial candidate neighboring blocks relative to a current block being encoded using IBC are the same as those shown in FIG. 15A for inter prediction. The five spatial candidate neighboring blocks are respectively denoted A₀, A₁, B₀, B₁, and B₂. In other implementations, the list of candidate BVPs may include more than two candidate BVPs.

Referring back to FIG. 16, in IBC mode applied for screen content, a reference block may be determined as a best matching reference block to a current block. For example, the arrows correspond to block vectors that indicate respective displacements from respective current blocks to respective reference blocks that best match the respective current blocks. In the examples shown in FIG. 16, the reference blocks match the respective current blocks and the calculated residuals would be small, if not zero. However, often, video content may be more efficiently encoded by considering symmetry properties. For example, it has been observed that symmetry is often present in video content, especially in text character regions and computer generated graphics in screen content video.

To increase compression efficiency, a Reconstruction-Reordered intra block copy IBC (RRIBC) mode (e.g., also referred to as IBC-Mirror Mode) was introduced for screen content video coding to take advantage of symmetry within video content to further improve the coding efficiency of IBC. For example, the RRIBC mode was adopted into the Enhanced Compression Model (ECM) software algorithm that is currently under coordinated exploration study by the Joint Video Exploration Team (JVET) of ITU-T Video Coding Experts Group (VCEG) and ISO/IEC MPEG as a potential enhanced video coding technology beyond the capabilities of VVC. In some examples, when the RRIBC mode is indicated for encoding a current block, a residual for the current block may be calculated based on samples of a reference block (e.g., corresponding to an original reference block being encoded and decoded to form a reconstructed block) being flipped relative to the current block according to a flip direction indicated for the current block. In an example, at the encoder side, the reference block may be flipped before matching and residual calculation, while the current block (to be predicted) may be derived without flipping. Similarly, at the decoder side, the reference block (that was encoded) may be flipped back to restore the original reference block before being flipped at the encoder side. In another example, at the encoder side, the current block (to be predicted) may be flipped before matching and residual calculation, while the reference block (to which the current block is compared) may be determined without flipping. Similarly in this example, at the decoder side, the reconstructed current block (determined based on the residual and the reference block) may be flipped back to restore the original current block before being flipped at the encoder side.

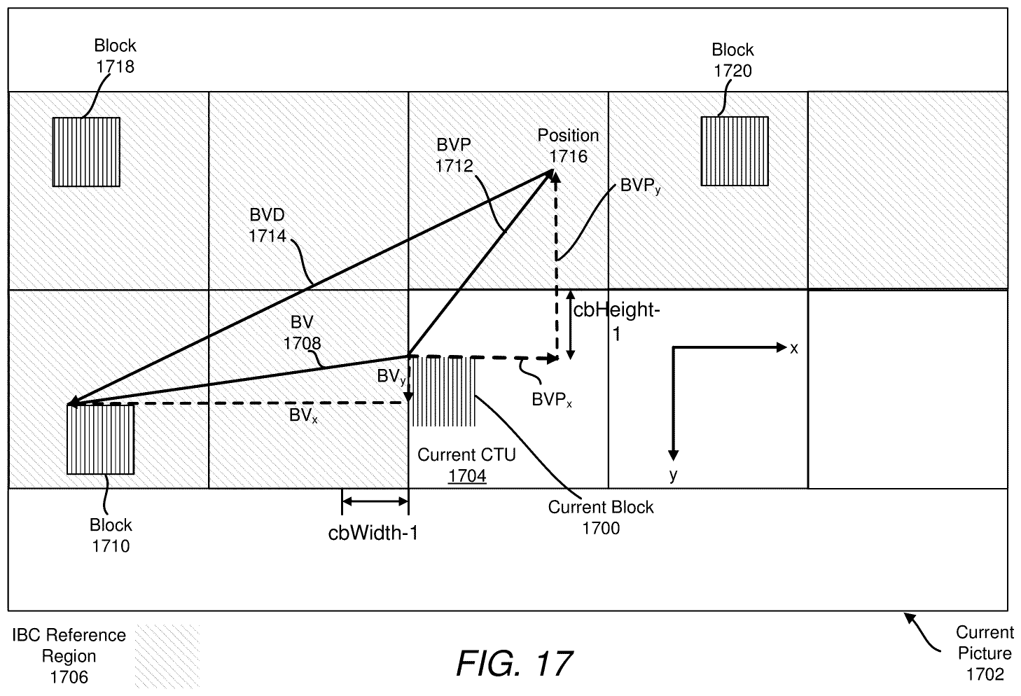

FIG. 17 illustrates an example of IBC coding using a block vector difference (BVD), according to some embodiments. In FIG. 17, an encoder, such as encoder 200 in FIG. 2, uses an IBC mode to code a current block 1700 in a current picture (or portion of a current picture) 1702. Current block 1700 may be a coding block (CB) within a coding tree unit (CTU) 1704. Unlike inter prediction that searches for a reference block in a prior decoded picture that is different than the picture of the current block being encoded, IBC searches for a reference block in the same, current picture as the current block. As a result, only part of the current picture may be available for searching for a reference block in IBC. For example, only the part of the current picture that has been decoded prior to the encoding of the current block. This may ensure the encoding and decoding systems can produce identical results but also limits the IBC reference region.

In HEVC, VVC, and other video compression standards, blocks may be scanned from left-to-right, top-to-bottom using a z-scan to form the sequence order for encoding/decoding. Based on the z-scan, CTUs (represented by the large, square tiles in FIG. 17) to the left and above current CTU 1704 may be encoded/decoded prior to current CTU 1704 and current block 1700. Therefore, the samples of these CTUs (shown with hatching in FIG. 17) may form an exemplary IBC reference region 1706 for determining a reference block to predict current block 1700. In other video encoders and decoders, a different sequence order for encoding/decoding may be used, which may influence IBC reference region 1706 accordingly.

In addition to the encoding/decoding sequence order, one or more additional reference region constraints may be placed on IBC reference region 1706. For example, IBC reference region 1706 may be constrained based on a limited memory for storing reference samples or to CTUs based on a parallel processing approach, like tiles or wavefront parallel processing (WPP). Tiles may be used as part of a picture partitioning process for flexibly subdividing a picture into rectangular regions of CTUs such that coding dependencies between CTUs of different tiles are not allowed. WPP may be similarly used as part of a picture partitioning process for partitioning a picture into CTU rows such that dependencies between CTUs of different partitions are not allowed. Each of these tools may enable parallel processing of the picture partitions.

It should be noted that reference to a position of a block throughout this disclosure refers to the position of the block's top-left sample. However, in other examples, the position of a block may be determined by the position of another sample in the block. The position of a sample in a picture is indicated by a sample number in the horizontal direction (given by the variable x) and a sample number in the vertical direction (given by the variable y) relative to the origin ((x, y)=(0,0)) of the picture coordinate system in the top left corner of the picture or relative to the top left sample of a block (e.g., a CTU) in which the sample is located within. In the horizontal x direction, the positive direction is to the right. Thus, as x increases, the sample location moves farther right in the positive, horizontal direction. In the vertical y direction, the positive direction is down. Thus, as y increases, the sample location moves farther down in the positive, vertical direction.

Similar to how a motion vector (MV), a motion vector predictor (MVP), and a motion vector difference (MVD) are determined in inter-prediction, FIG. 17 shows that corresponding vectors: a block vector (BV) 1708, a block vector predictor (BVP) 1712, and a block vector difference (BVD) 1714 can be determined. For example, the encoder may apply a block matching technique to determine BV 1708 that indicates the relative displacement from current block 1700 to a reference block shown as block 1710 (or intra block compensated prediction) within IBC reference region 1706 that “best matches” current block 1700. For example, block 1710 may have been determined as the reference block from IBC reference region 1706 as being a better match than other blocks such as block 1718 and block 1720 within IBC reference region 1706. In an example, IBC reference region 1706 is a constraint placed on BV 1708. BV 1708 is constrained by IBC reference region 1706 to indicate a displacement from current block 1700 to a reference block (shown as block 1710) that is within IBC reference region 1706. The encoder may determine the best matching reference block as block 1710 from blocks tested such as blocks 1718 and 1720, within IBC reference region 1706, during a searching process. The encoder may determine that a reference block is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the prediction samples of the reference block and the original samples of the current block. Reference block 1710 may comprise decoded (or reconstructed) samples of current picture 1702 prior to being processed by in-loop filtering operations, like deblocking or SAO filtering.

Once reference block 1710 is determined and/or generated for current block 1700 using IBC, the encoder may determine or use a difference (e.g., a corresponding sample-by-sample difference) between current block 1700 and reference block 1710. The difference may be referred to as a prediction error or residual. The encoder may then store and/or signal in a bitstream the prediction error and the related prediction information for decoding.

The prediction information may include BV 1708. In other instances, the prediction information may include an indication of BV 1708. For example, in HEVC, VVC, and other video compression schemes, BV 1708 may be predictively coded before being stored or signaled in a bit stream as explained previously above. BV 1708 for current block 1700 may be predictively coded using a similar technique as AMVP for inter prediction. This technique may be referred to as BV prediction and difference coding. For the BV prediction and difference coding technique, the encoder may code BV 1708 as a difference between BV 1708 and BVP 1712. The encoder may select BVP 1712 from a list of candidate BVPs. In an example, BVP 1712 points to a position 1716 within IBV reference region 1706. The candidate BVPs may come from previously decoded BVs of neighboring blocks of current block 1700 or from other sources. In one example, where a BV from a neighboring block of current block 1700 is not available, a null BVP candidate (e.g., with an x-component and y-component with zero magnitude) may be added to the list of candidate BVPs. Both the encoder and decoder may generate or determine the list of candidate BVPs.

After the encoder selects BVP 1712 from the list of candidate BVPs, the encoder may determine BVD 1714. BVD 1714 may be calculated based on the difference between BV 1708 and BVP 1712. For example, BVD 1714 may be represented by two directional components calculated according to equations (17) and (18) above for BVDₓ and BVD_{y}, which are reproduced below:

$$B V {D}_{x} = B V x - B V {P}_{x} \qquad ( 17 )$$

$$B V {D}_{y} = B V y - B V {P}_{y} \qquad ( 18 )$$

where BVDₓ and BVD_{y} respectively represent the horizontal and vertical components of BVD 1714, BVₓ and BV_{y} respectively represent the horizontal and vertical components of BV 1708, and BVPₓ and BVP_{y} respectively represent the horizontal and vertical components of BVP 1712. The horizontal x-axis and vertical y-axis are indicated in the lower right hand corner of current picture 1702 for reference purposes. In the example of FIG. 17, the x-axis increases from left to right, and the y-axis increases from top to bottom.

The encoder may signal, in a bitstream, the prediction error (or residual), an indication of the selected BVP 1712 (e.g., via an index pointing into the list of candidate BVPs), and the separate components of BVD 1714 given by equations (17) and (18). A decoder, such as decoder 300 in FIG. 3, may decode BV 1708 by adding corresponding components of BVD 1714 to corresponding components of BVP 1712 indicated in the bitstream. The decoder may then decode current block 1700 by determining (e.g., generating) reference block 1710, which forms the prediction of current block 1700, using the decoded BV and combining the prediction with the prediction error received in the bitstream.

As explained above with respect to FIG. 2 and FIG. 3, entropy coding may be performed at the end of the video encoding process and at the beginning of the video decoding process. Entropy coding is a technique for compressing a sequence of symbols by representing symbols with greater probability of occurring using fewer bits than symbols with less probability of occurring. When the compressed sequence of symbols is represented in bits {0, 1}, Shannon's information theory provides that the optimal average code length for a symbol with probability p is −log 2(p).

In some embodiments, to encode or decode video content, syntax elements of a video sequence are entropy encoded or decoded, respectively. These syntax elements may be generated at a video encoder and may describe how a video signal may be reconstructed at a video decoder. For a coding unit (CU), the syntax elements may include an intra prediction mode based on the CU being intra predicted, motion data (e.g., MVD and MVP related data) based on the CU being inter predicted, or displacement data (e.g., BVD and BVP related data) based on the CU being predicted using IBC or RRIBC mode.

In some embodiments, to encode the syntax elements, the encoder (e.g., entropy coding unit 218) may include a binarizer that maps a value of a syntax element to a sequence of binary symbols (also referred to as a bin-string). The binarizer may define a unique mapping of values of syntax element to sequences of binary symbols. In other words, the binarizer may generate a binary representation of a non-binary valued syntax element. Binarization of syntax elements may help to improve probability modeling and implementation of arithmetic encoding. As is well known to a skilled person, the bits of the binary string, to which the value of the syntax element has been binarized, is sometimes referred to as bins and a bin may refer to one of the bits of the binary string.

In existing technologies, the magnitudes of the BVD and/or the MVD may be coded (e.g., binarized) using any of a wide class of codes that include a first part (e.g., a prefix or prefix part) that indicates a range of values and a second part (e.g., a suffix or a suffix part) that indicates a precise value within the range of values, such as Rice codes, Golomb codes (e.g., Golomb-Rice codes or Exponential Golomb codes), and fixed length codes.

For example, in the example of FIG. 17, a magnitude of a horizontal component BVx of BVD 1714 may be binarized using a Golomb-Rice code. Golomb-Rice codes have the structure discussed above, with a first part that that indicates a range of values and a second part that indicates a precise value within the range of values. In Golomb-Rice codes, the first part is referred to as the “prefix” part and the second part is referred to as the “suffix” part. A Golomb-Rice code Cgr k(v) of order k includes a unary coded prefix and k suffix bits (i.e., suffix with a bit-length of k). The k suffix bits are a binary representation of an integer 0≤i<2^{k}. Golomb codes further use a tunable parameter M to divide an input value v into the prefix part and the suffix part—specifically, a prefix value q, which is the result of a division by M, and a suffix value vₛ, which is the remainder. Golomb-Rice codes are a class of Golomb codes where the parameter Mis an exponent of 2 such as 2^{k}. For the input value v where v is a non-negative integer, the prefix part (q) and the suffix part (vₛ) may be determined by:

$$q = ⌊ \frac{v}{{2}^{k}} ⌋ . \qquad ( 21 )$$

$${v}_{s} = v - q ( {2}^{k} ) . \qquad ( 22 )$$

An example of a Golomb-Rice code for k=4 is given in Table 1 below. In the table and the following explanation, x₀, x₁, . . . , xₙ denote bits of the codeword with xₙ∈{0, 1}.

TABLE 1

| v | Cgr 4(v) |
|---|---|
| 0, . . . , 15 | 0 x3, x2, x1, x0 |
| 16, . . . , 31 | 1 0 x3, x2, x1, x0 |
| 32, . . . , 47 | 1 1 0 x3, x2, x1, x0 |
| . | . |
| . | . |
| . | . |

The number of prefix bits is denoted by Nₚ, the number of suffix bits is denoted by Nₛ. For the Golomb-Rice code, the number of suffix bits is nₛ=k. When encoding a value v, the number of prefix bits is determined by:

$${N}_{p} = 1 + ⌊ \frac{v}{{2}^{k}} ⌋ . \qquad ( 23 )$$

└x┘ is the integer part of x. The suffix is the nₛ-bit representation of (24) which is equivalent to (22):

$${v}_{s} = v - {2}^{k} ( {N}_{p} - 1 ) . \qquad ( 24 )$$

The Golomb-Rice codes discussed above use a suffix of fixed length. The length of the suffix may also be determined by the length of the prefix. Exponential Golomb codes (Exp-Golomb) use this approach and can further be used to binarize the magnitude of a component, of BVD. A kth-order Exp-Golomb code C_{eg k}(v) includes a unary prefix code and a suffix of variable length. The number of bits in the suffix Nₛ (also referred to as a bit-length of the suffix) is determined by the value Nₚ as follows:

$${N}_{s} = k + {N}_{p} - 1 . \qquad ( 25 )$$

The number of prefix bits Nₚ (also referred to as a bit-length of the prefix) of C_{eg k}(v) is determined from the value v by:

$${2}^{k} ( {2}^{{N}_{p} - 1} - 1 ) \leq v < {2}^{k} ( {2}^{{N}_{p}} - 1 ) . \qquad ( 26 )$$

The suffix is then the nₛ-bit representation of:

$${v}_{s} = v - {2}^{k} ( {2}^{{N}_{p} - 1} - 1 ) . \qquad ( 27 )$$

In some examples, the codeword (v_{c}) that represents the value v may be the prefix value vₚ concatenated to the suffix value vₛ. Therefore, the number of bits of the codeword N_{c} (also referred to as a bit-length of the codeword) may be determined as follows:

$${N}_{c} = {N}_{p} + {N}_{s} . \qquad ( 28 )$$

In some embodiments, the prefix part may be unary coded such that the prefix value may be represented as a unary value (including a run of i=nₚ−1 bits of 1's) followed by a termination bit (also referred to as separator bit or a delimiter bit) of opposite value (e.g., 0) to a bit of the unary value. In some examples, the bit values may be swapped, e.g., the unary value may have a run of i 0's and the termination bit is 1. For the number i that also represent a prefix group index that starts at 0, the suffix part may be determined as a (k+i)-bit binary number, which is logically equivalent to (25) (i.e., nₚ−1=i).

After the binarizer maps the value of a syntax element to a sequence of binary symbols, one or more of the binary symbols may be processed by an arithmetic encoder, which may process each of the one or more binary symbols in one of at least two modes: regular arithmetic encoding mode or bypass arithmetic encoding mode to further increase compression.

In some embodiments, to decode the binarized syntax elements, the decoder (e.g., entropy decoding unit 306) may include a debinarizer that reverses the operation of the binarizer and may map the sequence of binary symbols in a bitstream (including a video sequence) to the value of syntax element. Similarly, the decoder may include an arithmetic decoder to reverse (i.e., decode) the arithmetic encoding of the encoded syntax element in the bitstream before the debinarizer determines the value of the syntax element from the sequence of binary symbols.

Arithmetic coding is one method of entropy coding. Arithmetic coding is based on recursive interval subdivision. To arithmetic encode a symbol that takes a value from an m-ary source alphabet, an initial coding interval may be divided into m disjoint subintervals. Each of the m disjoint subintervals may have a width proportional to the probability of the symbol having a different one of the values in the m-ary source alphabet. The probabilities of the symbol having the different values in the m-ary source alphabet may be referred to as a probability model for the symbol. The symbol is arithmetic encoded by choosing the subinterval corresponding to the actual value of the symbol as the new coding interval. By recursively applying this interval-subdivision scheme to each symbol sᵢ of a given sequence s={s₁, s₂, . . . , s_{N}), the encoder may determine a value in the range of the final coding interval, after the Nth interval subdivision, as the arithmetic codeword for the sequence s. Each successive symbol of the sequence s that is encoded reduces the size of the coding interval in accordance with the probability model of the symbol. The more likely symbol values reduce the size of the coding interval by less than the unlikely symbol values and hence add fewer bits to the arithmetic codeword for the sequence s in accordance with the general principle of entropy coding.

Arithmetic decoding is based on the same recursive interval subdivision. To arithmetic decode a symbol that takes a value from an m-ary source alphabet, an initial coding interval may be divided into m disjoint subintervals. Each of the m disjoint subintervals may have a width proportional to the probability of the symbol having a different one of the values in the m-ary source alphabet. The probabilities of the symbol having the different values in the m-ary source alphabet may be referred to as a probability model for the symbol as mentioned above. The symbol is arithmetic decoded from an arithmetic codeword by determining the symbol value corresponding to the subinterval in which the arithmetic codeword falls within. This subinterval then becomes the new coding interval. The decoder may sequentially decode each symbol sᵢ of a sequence s={s₁, s₂, . . . , s_{N}) by recursively applying this interval-subdivision scheme N times and determining which subinterval the arithmetic codeword falls within during each iteration.

For each symbol arithmetic coded, a different probability model may be used to subdivide the coding interval. For example, the probability model for a symbol may be determined by a fixed selection (e.g., based on a position of the symbol in a sequence of symbols representing a syntax element) or by an adaptive selection from among two or more probability models (e.g., based on information related to the symbol). It is also possible for two or more symbols in a sequence of symbols to use a joint probability model. Selection of a probability model for a symbol is referred to as context modeling. Arithmetic coding that employs context modeling may be referred to more specifically as context-based arithmetic coding. In addition to probability model selection for a symbol, the selected probability model may be updated based on the actual coded value of the symbol. For example, the probability of the actual coded value of the symbol may be increased in the probability model while the probability of all other values may be decreased. Arithmetic coding that employs both context modeling and probability model adaptation may be referred to more specifically as context-based adaptive arithmetic coding.

The above description provides only one example of arithmetic coding. Other variations of arithmetic coding may be possible as would be appreciated by a person of ordinary skill in the art. For example, during arithmetic coding, a renormalization operation may be performed to ensure that the precision needed to represent the range and lower bound of a subinterval does not exceed the finite precision of registers used to store these values. In addition, other simplifications to the coding process may be made to decrease complexity, increase speed, and/or reduce power requirements of the implementation of the coding process in either hardware, software, or some combination of the two. For example, probabilities of symbols and lower bounds and ranges of subintervals may be approximated or quantized in such implementations.

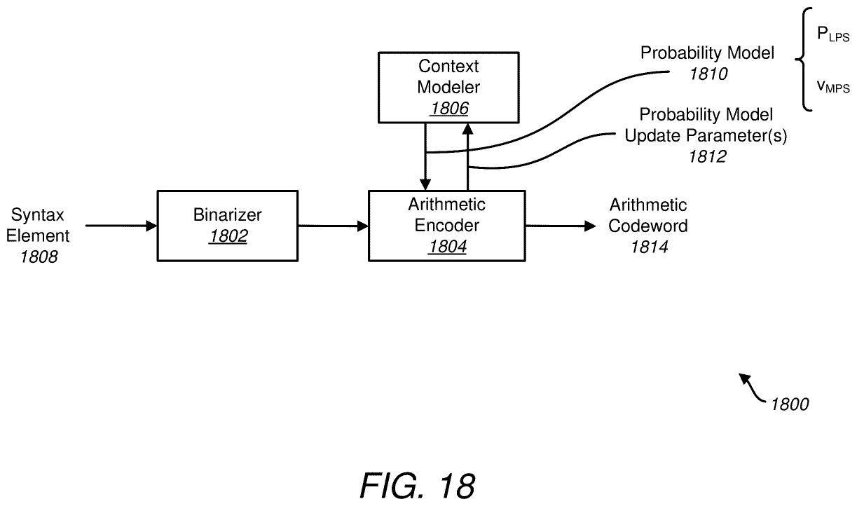

FIG. 18 illustrates an example implementation of a context-based adaptive binary arithmetic coding (CABAC) encoder 1800, according to some embodiments. CABAC encoder 1800 may be implemented in a video encoder, such as video encoder 200 in FIG. 2, for entropy encoding syntax elements of a video sequence. As illustrated in FIG. 18, CABAC encoder 1800 includes a binarizer 1802, an arithmetic encoder 1804, and a context modeler 1806.

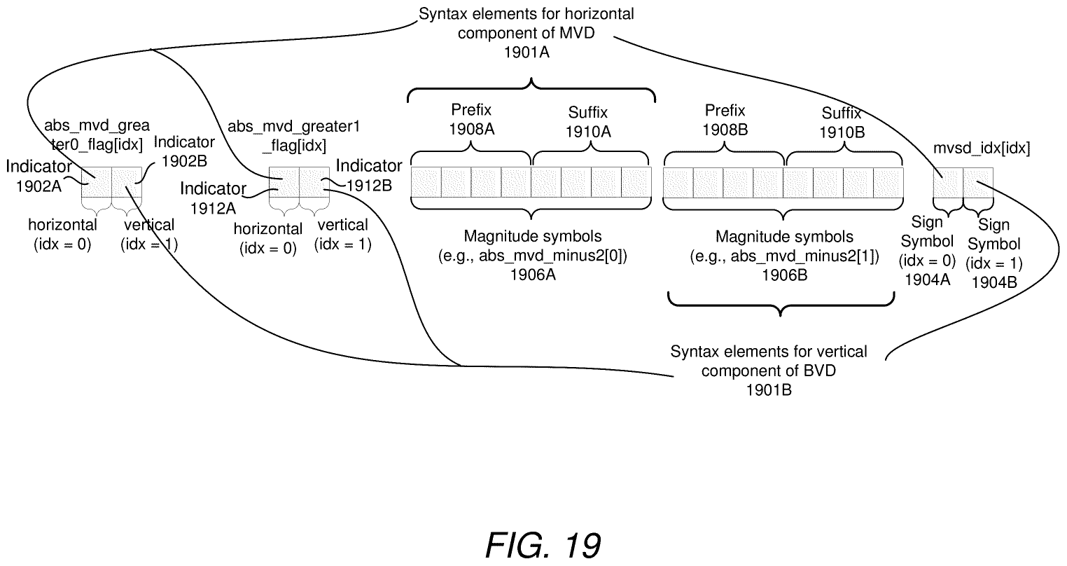

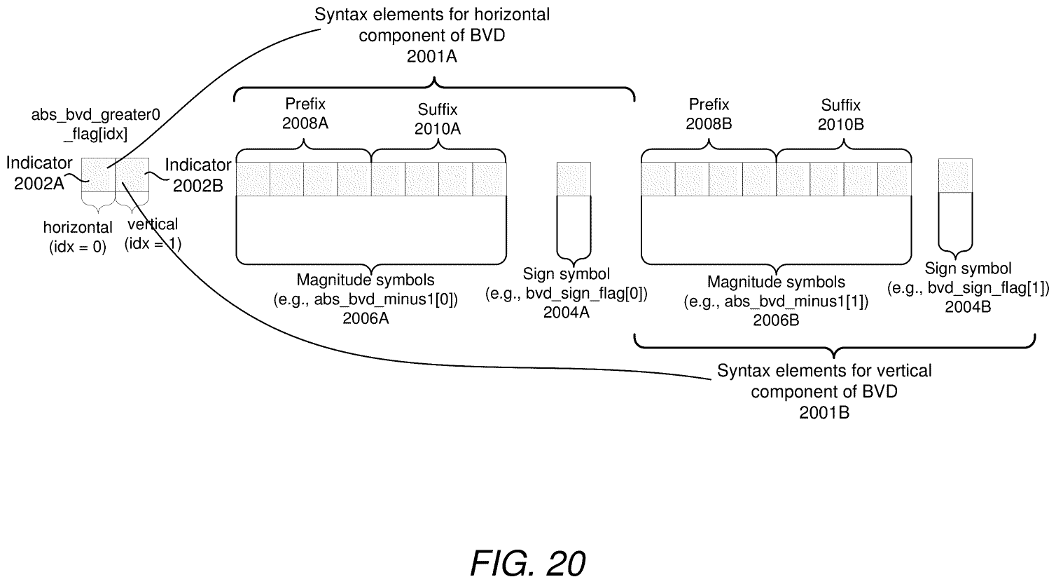

CABAC encoder 1800 may receive a syntax element 1808 for arithmetic encoding. Syntax elements, such as syntax element 1808, may be generated at a video encoder and may describe how a video signal may be reconstructed at a video decoder. For a coding unit (CU), the syntax elements may comprise an intra prediction mode based on the CU being intra predicted, motion data (e.g., MVD and MVP related data) based on the CU being inter predicted, or displacement data (e.g., BVD and BVP related data) based on the CU being predicted using IBC. For example, syntax element 1808 may include symbols representing an MVD or a BVD, as will be further described below with respect to FIG. 19 and FIG. 20.

Binarizer 1802 may first map the value of syntax element 1808 to a sequence of binary symbols (also referred to as a bin string or a sequence of bins). Binarizer 1802 may define a unique mapping of values of syntax element 1808 to respective sequences of binary symbols. Therefore, the binarizer may generate a binary representation of a non-binary valued syntax element. Binarization of syntax elements may help to improve probability modeling and implementation of arithmetic encoding. Binarizer 1802 may implement one or more binarization processes, such as unary, truncated unary, k-th order truncated Rice, k-th order exponential-Golomb (EGk), fixed-length, or some combination of two or more of these binarization processes. Binarizer 1802 may select a binarization process based on a type of syntax element 1808 and/or one or more syntax elements processed by CABAC encoder 1800 before syntax element 1808. Based on syntax element 1808 already being represented by a sequence of one or more binary symbols, binarizer 1802 may not process syntax element 1808. In another example, binarizer 1802 may not be used and syntax element 1808 represented by a sequence of one or more non-binary symbols may be directly encoded by CABAC encoder 1800.

After binarizer 1802 optionally maps the value of syntax element 1808 to a sequence of binary symbols, one or more of the binary symbols may be processed by arithmetic encoder 1804. Arithmetic encoder 1804 may process each of the one or more binary symbols in one of at least two modes: regular arithmetic encoding mode (“regular mode”) or bypass arithmetic encoding mode (“bypass mode”).

Arithmetic encoder 1804 may process binary symbols that do not have a uniform (or approximately uniform) probability distribution in regular arithmetic encoding mode (e.g., binary symbols that do not have a probability distribution of 0.5 for each of their two possible values). In regular arithmetic encoding mode, arithmetic encoder 1804 may perform arithmetic encoding as described above. For example, arithmetic encoder 1804 may subdivide a current coding interval into m disjoint subintervals. Each of the m disjoint subintervals may have a width proportional to the probability of the binary symbol having a different one of the values in an m-ary source alphabet. In the case of a binary symbol, m is equal to two and the current coding interval may be subdivided into two disjoint intervals that each have a width proportional to the probability of a different one of the two possible values {0, 1} for the binary symbol being encoded. The probabilities of the two possible values for the binary symbol may be indicated by a probability model 1810 for the binary symbol. Arithmetic encoder 1804 may then encode the binary symbol by choosing the subinterval corresponding to the actual value of the binary symbol as the new coding interval for the next binary symbol to be encoded.

Arithmetic encoder 1804 may receive probability model 1810 from context modeler 1806. Context modeler 1806 may determine probability model 1810 for the binary symbol by a fixed selection (e.g., based on a position of the binary symbol in the sequence of binary symbols representing syntax element 1808) or by an adaptive selection from among two or more probability models (e.g., based on information related to the binary symbol). As shown in FIG. 18, probability model 1810 may comprise two parameters: the probability P_{LPS} of the least probable symbol (LPS) and the value v_{MPS} of the most probable symbol (MPS). In other examples, probability model 1810 may comprise the probability P_{MPS} of the MPS in addition or alternatively to the probability P_{LPS} of the LPS. Similarly, in other examples, probability model 1810 may comprise the value v_{LPS} of the LPS in addition or alternatively to the value v_{MPS} of the MPS. After arithmetic encoder 1804 encodes the binary symbol, arithmetic encoder 1804 may provide one or more probability model update parameters 1812 to context modeler 1806. Context modeler 1806 may adapt probability model 1810 based on the one or more probability model update parameters 1812. For example, the one or more probability model update parameters 1812 may comprise the actual coded value of the binary symbol. Context modeler 1806 may update probability model 1810 by increasing P_{LPS} if the actual coded value of the binary symbol is not equal to v_{MPS} and by decreasing P_{LPS} otherwise.

Arithmetic encoder 1804 may process binary symbols that have (or are assumed to have) a uniform (or approximately uniform) probability distribution in bypass arithmetic encoding mode. Because binary symbols processed by arithmetic encoder 1804 in bypass arithmetic encoding mode have (or are assumed to have) a uniform (or approximately uniform) probability distribution, arithmetic encoder 1804 may bypass probability model determination and adaptation performed in regular arithmetic encoding mode when encoding these binary symbols to speed up the encoding process. In addition, subdivision of the current coding interval may be simplified given the uniform (or assumed uniform) probability distribution. For example, the current coding interval may be partitioned into two disjoint subintervals of equal width, which may be realized using a simple implementation that may further speed up the encoding process. Arithmetic encoder 1804 encodes the binary symbol by choosing the subinterval corresponding to the value of the binary symbol as the new coding interval for the next binary symbol to be encoded. The resulting increase in encoding speed for binary symbols encoded by arithmetic encoder 1804 in bypass arithmetic encoding mode is often important because CABAC encoding may have throughput limitations.

After processing a number of binary symbols (e.g., corresponding to one or more syntax elements), arithmetic encoder 1804 may determine a value in the range of the final coding interval as an arithmetic codeword 1814 for the binary symbols. Arithmetic encoder 1804 may then output arithmetic codeword 1814. For example, arithmetic encoder 1804 may output arithmetic codeword 1814 to a bitstream that may be received and processed by a video decoder.

In some embodiments, to decode arithmetic codeword 1814 representing an encoded syntax elements, a decoder (e.g., entropy decoding unit 306) may include an arithmetic decoder to reverse (i.e., decode) the arithmetic encoding of the encoded syntax element to determine a sequence of binary symbols (or bins). Then, a (de)binarizer (of the decoder) may reverse the operation of the binarizer and may map the sequence of binary symbols to a value of syntax element 1808.

FIG. 19 illustrates an example of syntax elements of a motion vector difference (MVD), according to some embodiments. The syntax elements may include syntax elements 1901A for a horizontal component of MVD and syntax elements 1901B for a vertical component of MVD. FIG. 19 illustrates an example ordering of syntax elements that are coded (e.g., encoded and transmitted, or parsed and decoded).

In some examples, a value of a horizontal component of the MVD may be represented by or derived from syntax elements 1901A. Syntax elements 1901A may include an indicator 1902A (e.g., abs_mvd_greater0_flag[0]), an indicator 1912A (e.g., abs_mvd_greater1_flag[0]), magnitude symbols 1906A (e.g., abs_mvd_minus2[0]), and a sign symbol 1904A (e.g., mvsd_idx[0]). Similarly, syntax elements 1901B may include an indicator 1902B (e.g., abs_mvd_greater0_flag[1]), an indicator 1912B (e.g., abs_mvd_greater1_flag[1]), magnitude symbols 1906B (e.g., abs_mvd_minus2[1]), and an indicator 1904B of a sign symbol (e.g., mvsd_idx[1]).

For ease of explanation, the syntax elements will be described below with respect to the horizontal component. However, the following descriptions of syntax elements are similarly applicable to the vertical component. Indicator 1902A indicates whether an absolute value of the horizontal component is greater than 0. For example, indicator 1902A being set (or determined) as, e.g., a binary 1 may indicate that the absolute value of the horizontal component is greater than 0. In this example, indicator 1902B being set to the opposite value of binary 0 would indicate that the absolute value of the horizonal component is not greater than 0; in other words, the horizontal component has a value of 0. In some examples, if indicator 1902A indicates that the horizontal component has a value of 0, then syntax elements such as indicator 1912A and magnitude symbols 1906A and sign symbol 1904A may be skipped and not transmitted/parsed. In some examples, indicator 1902A may be context coded using an arithmetic coder such as that described in FIG. 18.

Indicator 1912A indicates whether an absolute value of the horizontal component is greater than 1. For example, indicator 1912A being set (or determined) as, e.g., a binary 1 may indicate that the absolute value of the horizontal component is greater than 1. In this example, indicator 1912B being set to the opposite value of binary 0 would indicate that the absolute value of the horizonal component is not greater than 1; in other words, if indicator 1902A is true and indicator 1912A is false, then the horizontal component has a value of 1. In some examples, if indicator 1912A indicates that the horizontal component has a value of 1, then syntax elements such as magnitude symbols 1906A may be skipped and not transmitted/parsed. However, sign symbol 1904A may still be parsed to derive a positive sign or a negative sign for the value of the horizontal component of the MVD. In some examples, indicator 1912A may be context coded using an arithmetic coder such as that described in FIG. 18.

Magnitude symbols 1906A may include symbols in prefix 1908A and symbols in suffix 1910A. Together, as described above with respect to FIG. 18 and further described below, prefix 1908A and suffix 1910A may indicate a value of the MVD. For example, prefix 1908A and suffix 1910A may form a codeword determined using an Golomb code such as Ex-Golomb code. In some examples, magnitude symbols 1906A may be determined if indicator 1912A indicates that the absolute value is greater than 1; in other words, the absolute value of the horizontal component of the MVD is at least 2. Therefore, magnitude symbols 1906A may correspond to an absolute value of the horizontal component of the MVD minus 2. To determine the value of the horizontal component, the value represented by magnitude symbols 1906A is added to two. In some examples, symbols of prefix 1908A may be context coded using an arithmetic coder such as that described in FIG. 18. In other examples, symbols of prefix 1908A may be bypass coded using an arithmetic coder such as that described in FIG. 18.

In some examples, symbols of suffix 1910A may be bypass coded using an arithmetic coder such as that described in FIG. 18. In some examples, one or more symbols of suffix 1910A may be context coded using an arithmetic coder such as that described in FIG. 18. In some examples, one or more symbols of suffix 1910A may be coded as verification indications. For example, a symbol coded as a verification indication may indicate whether a predicted value of the symbol is equal to (or matches) the value of the symbol. This verification indication may be context coded using an arithmetic coder such as that described in FIG. 18.

Sign symbol 1904A may indicate whether the value of the horizontal component is positive (e.g., a binary of 1) or negative (e.g., an opposite binary value of 0). In some examples, sign symbol 1904A may be context coded using an arithmetic coder such as that described in FIG. 18.

Table 2 below shows an example of the order in which syntax elements for the horizontal component (e.g., having an index of 0) and the syntax elements for the vertical component (e.g., having an index of 1) are determined by the encoder (e.g., encoded) and the decoder (e.g., parsed and decoded). As shown below and as described above, certain syntax elements may be skipped depending on the value of previous syntax elements.

TABLE 2
Motion Vector Difference Syntax

| | Descriptor |
|---|---|
| mvd_coding( x0, y0, refList ,cpIdx ) { | |
| abs_mvd_greater0_flag[ 0 ] | ae(v) |
| abs_mvd_greater0_flag[ 1 ] | ae(v) |
| if( abs_mvd_greater0_flag[ 0 ] ) | |
| abs_mvd_greater1_flag[ 0 ] | ae(v) |
| if( abs_mvd_greater0_flag[ 1 ] ) | |
| abs_mvd_greater1_flag[ 1 ] | ae(v) |
| if( abs_mvd_greater0_flag[ 0 ] ) { | |
| if( abs_mvd_greater1_flag[ 0 ] ) | |
| abs_mvd_minus2[ 0 ] | ae(v) |
| mvd_sign_flag[ 0 ] | ae(v) |
| } | |
| if( abs_mvd_greater0_flag[ 1 ] ) { | |
| if( abs_mvd_greater1_flag[ 1 ] ) | |
| abs_mvd_minus2[ 1 ] | ae(v) |
| mvd_sign_flag[ 1 ] | ae(v) |
| } | |
| } | |

FIG. 20 illustrate an example of syntax elements of a block vector difference (BVD), according to some embodiments. The syntax elements may include syntax elements 2001A for a horizontal component of the BVD and syntax elements 2001B for a vertical component of the BVD. FIG. 20 illustrates an example ordering of syntax elements that are coded (e.g., encoded and transmitted, or parsed and decoded).

In some examples, a value of a horizontal component of the BVD may be represented by or derived from syntax elements 2001A. Syntax elements 2001A may include an indicator 2002A (e.g., abs_bvd_greater0_flag[0]), magnitude symbols 2006A (e.g., abs_bvd_minus1[0]), and a sign symbol 2004A (e.g., bvd_sign_flag[0]). Similarly, syntax elements 2001B may include an indicator 2002B (e.g., abs_bvd_greater0_flag[1]), magnitude symbols 2006B (e.g., abs_bvd_minus1[1]), and a sign symbol 2004B (e.g., bvd_sign_flag[1]). These syntax elements are analogous and similarly named to the syntax elements described above with respect to the MVD in FIG. 19.

In the example of FIG. 20, the syntax elements for the BVD do not include two indicators indicating whether absolute values of the two components of the BVD are greater than one. Because of this difference, magnitude symbols 2006A for the horizontal component, if present, corresponds to an absolute value of the BVD minus one. In other words, the absolute value of the horizontal component of the BVD is equal to the value represented by magnitude symbols 2006A plus one. In other examples (not shown), the syntax elements for the BVD may include two indicators indicating whether absolute values of the two components of the BVD are greater than one, similar to that shown for the MVD in FIG. 19.

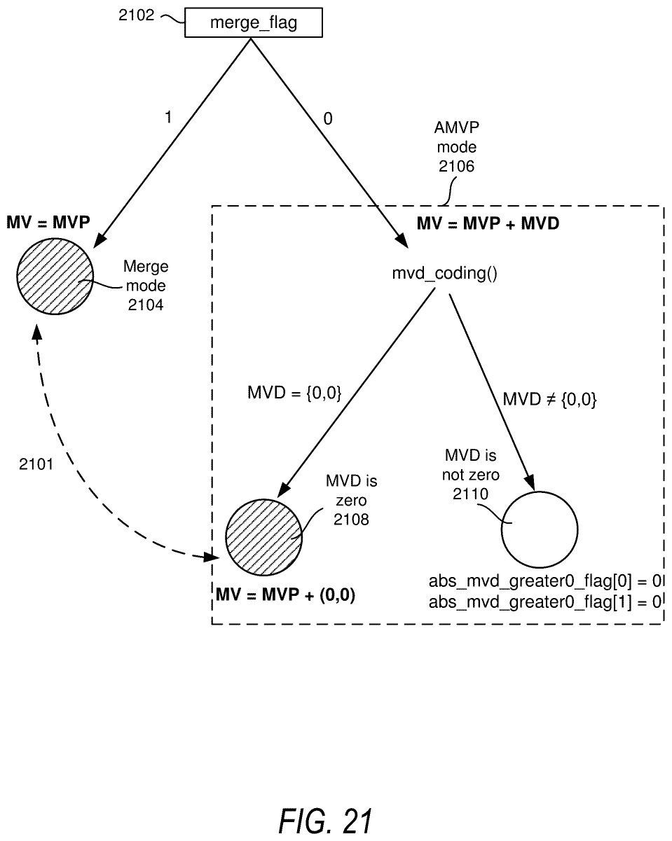

FIG. 21 illustrates an example of syntax elements indicating a merge mode or an advanced motion vector prediction (AMVP) mode, according to some embodiments.

In some examples, modes for coding blocks are indicated as part of coding unit syntax, a part of which is shown in Table 1 below.

TABLE 1
Portion of Coding Unit Syntax

| | |
|---|---|
| } else if( treeType != DUAL_TREE_CHROMA ) {/* MODE_INTER or MODE_IBC */ | |
| if( cu_skip_flag [ x0 ][ y0 ] == 0 ) | |
| general_merge_flag[ x0 ][ y0 ] | ae(v) |
| if( general_merge_flag[ x0 ][ y0 ] | |
| merge_data ( x0, y0, cbWidth, cbHeight, chType ) | |
| else if( CuPredMode[ chType ] [ x0 ][ y0 ] = = MODE_IBC ) { | |
| mvd_coding ( x0, y0, 0, 0 ) | |
| if( MaxNumIbcMergeCand > 1 ) | |
| mvp_10_flag[ x0 ][ y0 ] | ae(v) |
| if( sps_amvr_enabled_flag && | |
| ( MvdL0[ x0 ][ y0 ][ 0 ] != 0 ∥ MvdL0[ x0 ][ y0 ][ 1 ] != 0 ) ) | |
| amvr_precision_idx[ x0 ][ y0 ] | ae(v) |
| } else { | |
| if( sh_slice_type = = B ) | |
| inter_pred_idc[ x0 ][ y0 ] | ae(v) |
| if( sps_affine_enabled_flag && cbWidth >= 16 && cbHeight >= 16 ) { | |
| inter_affine_flag[ x0 ][ y0 ] | ae(v) |
| if( sps_6param_affine_enabled_flag && inter_affine_flag[ x0 ][ y0 ] ) | |
| cu_affine_type_flag[ x0 ][ y0 ] | ae(v) |
| } | |

For example, cu-skip-flag[x0][y0] equal to 1 specifies that for the current coding unit, when decoding a P or B slice, no more syntax elements except one or more of the following are parsed after cu_skip_flag[x0][y0]: the IBC mode flag pred_mode_ibc_flag [x0][y0], and the merge_data( ) syntax structure; when decoding an I slice, no more syntax elements except merge_idx[x0][y0] are parsed after cu_skip_flag[x0][y0]. cu-skip-flag[x0][y0] equal to 0 specifies that the coding unit is not skipped. The array indices x0, y0 specify the location (x0, y0) of the top-left luma sample of the considered coding block relative to the top-left luma sample of the picture. In an example, when cu-skip-flag[x0][y0] is not present, it is inferred to be equal to 0.

For example, general_merge_flag[x0][y0] specifies whether the inter prediction parameters for the current coding unit are inferred from a neighbouring inter-predicted partition. The array indices x0, y0 specify the location (x0, y0) of the top-left luma sample of the considered coding block relative to the top-left luma sample of the picture.

In an example, when general_merge_flag[x0][y0] is not present, it may inferred as follows: if cu_skip_flag[x0][y0] is equal to 1, general_merge_flag[x0][y0] is inferred to be equal to 1; otherwise, general_merge_flag[x0][y0] is inferred to be equal to 0.

In some examples, when cu_skip_flag or general_merge_flag are each equal to 1 for a block, MVD is not indicated in a bitstream (i.e., mvd_coding( ) structure is not present for such blocks). Instead, a merge_data( ) structure (as indicated above in Table 2) may be included as a part of signaling for a block (e.g., a coding unit). It includes signaling of a merge index (“merge_idx”) that specifies a MVP that is further used as a MV. More details on the components of a merge-data syntax structure are shown below in Table 3. None of these elements comprise indication of MVD.

TABLE 3
Merge data Syntax

| | Descriptor |
|---|---|
| merge_data( x0, y0, cbWidth, cbHeight, chType ) { | |
| if( CuPredMode[ chType ][ x0 ][ y0 ] = = MODE_IBC ) { | |
| if( MaxNumIbcMergeCand > 1 ) | |
| merge_idx[ x0 ][ y0 ] | ae(v) |
| } else { | |
| if( MaxNumSubblockMergeCand > 0 && cbWidth >= 8 && cbHeight >= | |
| 8 ) | |
| merge_subblock_flag[ x0 ][ y0 ] | ae(v) |
| if( merge_subblock_flag[ x0 ][ y0 ] = = 1 ) { | |
| if( MaxNumSubblockMergeCand > 1 ) | |
| merge_subblock_idx[ x0 ][ y0 ] | ae(v) |
| } else { | |
| if( cbWidth < 128 && cbHeight < 128 && | |
| ( ( sps_ciip_enabled_flag && cu_skip_flag[ x0 ][ y0 ] = = 0 && | |
| ( cbWidth * cbHeight ) >= 64 ) ∥ ( sps_gpm_enabled_flag && | |
| sh_slice_type = = B && cbWidth >= 8 && cbHeight >= 8 && | |
| cbWidth < ( 8 * cbHeight ) && cbHeight < ( 8 * cbWidth ) ) ) ) | |
| regular_merge_flag[ x0 ][ y0 ] | ae(v) |
| if( regular_merge_flag[ x0 ][ y0 ] = = 1 ) { | |
| if( sps_mmvd_enabled_flag ) | |
| mmvd_merge_flag[ x0 ][ y0 ] | ae(v) |
| if( mmvd_merge_flag[ x0 ][ y0 ] = = 1 ) { | |
| if( MaxNumMergeCand > 1 ) | |
| mmvd_cand_flag[ x0 ][ y0 ] | ae(v) |
| mmvd_distance_idx[ x0 ][ y0 ] | ae(v) |
| mmvd_direction_idx[ x0 ][ y0 ] | ae(v) |
| } else if( MaxNumMergeCand > 1 ) | |
| merge_idx[ x0 ][ y0 ] | ae(v) |
| } else { | |
| if( sps_ciip_enabled_flag && sps_gpm_enabled_flag && | |
| sh_slice_type = = B && | |
| cu_skip_flag[ x0 ][ y0 ] = = 0 && cbWidth >= 8 && | |
| cbHeight >= 8 && cbWidth < ( 8 * cbHeight ) && | |
| cbHeight < ( 8 * cbWidth ) && cbWidth < 128 && | |
| cbHeight < 128 ) | |
| ciip_flag[ x0 ][ y0 ] | ae(v) |
| if( ciip_flag[ x0 ][ y0 ] && MaxNumMergeCand > 1 ) | |
| merge_idx[ x0 ][ y0 ] | ae(v) |
| if( !ciip_flag[ x0 ][ y0 ] ) { | |
| merge_gpm_partition_idx[ x0 ][ y0 ] | ae(v) |
| merge_gpm_idx0[ x0 ][ y0 ] | ae(v) |
| if( MaxNumGpmMergeCand > 2 ) | |
| merge_gpm_idx1[ x0 ][ y0 ] | ae(v) |
| } | |
| } | |
| } | |
| } | |
| } | |

In existing technologies, there are two ways to indicate that a current block is predicted from a reference block having a motion vector (MV) that is equal to an MVP and no MVD information is indicated in the bitstream. For example, a merge flag 2102 is signaled to indicate whether a merge mode 2104 or an AMVP mode 2106 is selected or indicated. For example, if merge flag 2102 is equal to 1, syntax elements that relate to MVD are not signaled in the bitstream. In merge mode 2104, the selected or indicated MVP is used as the MV.

In another example, the merge flag being equal to 0 and syntax elements in the mvd_coding syntax structure may indicate that MVD is zero 2108. For example, as described above in FIG. 19, the mvd_coding syntax structure may include indicators 1902A and 1902B that indicate the horizontal and vertical components, respectively, of the MVD are not greater than 0. If at least one of indicators 1902A and 1902B is false, then the MVD is not zero 2110. For example, FIG. 21 shows that indicator 1902A (e.g., abs_mvd_greater0_flag[0]) may be 0 and indicator 1902B (e.g., abs_mvd_greater0_flag[1]) may be 0.

In some examples, merge flag 2102 may be set to 0 based on one or more of the following indications:
indicating that cu_skip_flag is equal to 1. When this flag is set to 0, merge_data structure is being signaled, and mvd_coding structure is not signaled;
indicating that general_merge_flag is equal to 1. This flag indicates whether the inter prediction parameters for the current coding unit are inferred from a neighboring inter-predicted partition;
indicating that tm_merge_flag is equal to 1. This flag indicates whether template matching operations were used to refine position of the MVP vector using template matching operations.

As show by arrow 2101 in FIG. 21, the MVD may be zero in both merge mode 2104 and AMVP mode 2106. However, the MVP may be different between merge mode 2104 and AMVP mode 2106 depending on how the MVP lists are generated.

In existing technologies, as shown in FIG. 19, the greater-than-0 indicators (i.e., indicators 1902A and 1902B) for components of an MVD are coded independently of each other. There are separate indicators transmitted for each component and contexts (i.e., also referred to as a context model or a probability model in this disclosure) for each indicator may be independently selected. Similarly, as shown in FIG. 20, the greater-than-0 indicators (i.e., indicators 2002A and 2002B) for components of a BVD are also coded independently of each other.

Embodiments of the present disclosure are directed to apparatuses and methods for improving the compression efficiency of the greater-than-0 indicators for components of the MVD. For example, the greater-than-0 indicators for components of the MVD are coded using at least one joint indicator to take advantage of statistics of values of the greater-than-0 indicators observed in test video content. Specifically, the probability of an absolute value of a component of the MVD (and also the BVD) being greater than 0 is higher than that of the absolute value being 0. In other words, a greater-than-0 indicator being true for a component of the MVD is higher than that of the greater-than-0 indicator being false. Similarly, the combination of the greater-than-0 indicators for the MVD each being true was observed to have a much higher probability than the combination of greater-than-0 indicators both being false and also higher than the probability of the combination of greater-than-0 indicators indicating one of the components is zero and the other has an absolute value greater than zero. Although the following embodiments are described with respect to MVD, they are equally applicable to BVD.

In some examples, values of one or more indications, to indicate whether an absolute value of a horizontal component of the MVD is greater than zero and whether an absolute value of a vertical component of the MVD is greater than zero, may be configured such that shorter codeword corresponds to higher probabilities of the values corresponding to the existing greater-than-0 indicators and longer codewords correspond to lower probabilities of the values corresponding to the existing greater-than-0 indicators. For example, one indicator (e.g., also referred to as a joint indicator) may indicate that both horizontal and vertical components have absolute values that are greater than 0.

In some examples, statistics of values for the greater-than-0 indicators may be used to increase compression by selecting a context for arithmetic coding a second indication, of whether an absolute value of a second component of the MVD is greater than 0, based on a value of a first indicator (previously determined or decoded) of whether an absolute value of a first component of the MVD is greater than 0. For example, the first indicator being true may indicate a higher probability of the second indicator also been true. Thus, a different context may be selected to code the second indicator.

These and other features of the present disclosure are described further below.

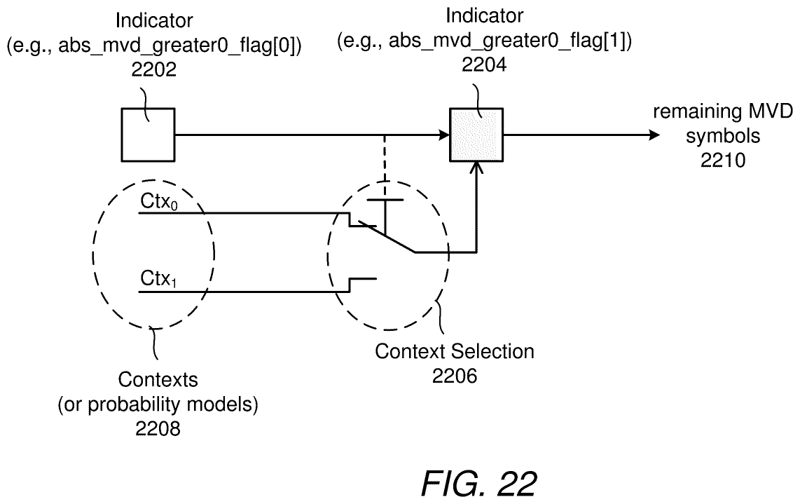

FIG. 22 illustrates an example of context coding a second indicator 2204 (e.g., abs_mvd_greater0_flag[1]), indicating whether a second component of an MVD is zero, based on a first indicator 2202 (e.g., abs_mvd_greater0_flag[0]) indicating whether a first component of the MVD is zero, according to some embodiments. For example, first indicator 2202 and second indicator 2204 may correspond to indicator 1902A and indicator 1904B, respectively, in FIG. 19, which correspond to a horizontal component and vertical component of the MVD. In other examples, first indicator 2202 and second indicator 2204 may correspond the vertical component and the horizontal component, respectively. Each of first indicator 2202 and second indicator 2204 may be context coded using an arithmetic coder such as CABAC, as described in FIG. 18.

In an embodiment, a context can be selected 2206 for encoding (and reciprocally selected at the decoder for decoding) second indicator 2204 based on a value of a previously parsed first indicator 2202. For example, when first indicator 2202 is equal to 0, it may indicate that the absolute value of the horizontal component of a coded MVD is equal to 0. In this example, first indicator 2202 may be arithmetic encoded (e.g., CABAC) using a probability model “Ctx0” (e.g., also referred to as a context model in CABAC). In a different example, when first indicator 2202 is equal to 1, it may indicates that the horizontal component of a coded MVD is non-zero (i.e., an absolute value of the horizontal component is greater than 0). In this example, first indicator 2202 may be arithmetic encoded using the next step of entropy coding of abs_mvd_greater0_flag[0] flag is perform using a context model “Ctx1” which is different from context model “Ctx0.”

As explained above, the probability that both the horizontal and vertical components of an MVD are zero is lower than any of the other 3 combinations of horizontal and vertical components being zero or non-zero. Because of the difference in probabilities, selection of different context models to encode a subsequent indicator such as second indicator 2204 based on a value of a prior coded first indicator 2202 increases efficiency of entropy coding, since probability (context) model is assigned in accordance with the probability of second indicator 2204 being equal to 1.

In some examples, if second indicator 2204 is indicated before first indicator 2202, then the context model for first indicator 2202 may be selected based on a value of second indicator 2204.

After transmitting (by the encoder) and receiving/parsing (by the decoder) indicator 2202 and indicator 2204, remaining MVD symbols 2210 may be processed as described above with respect to FIG. 19 for MVD and FIG. 20 for BVD.

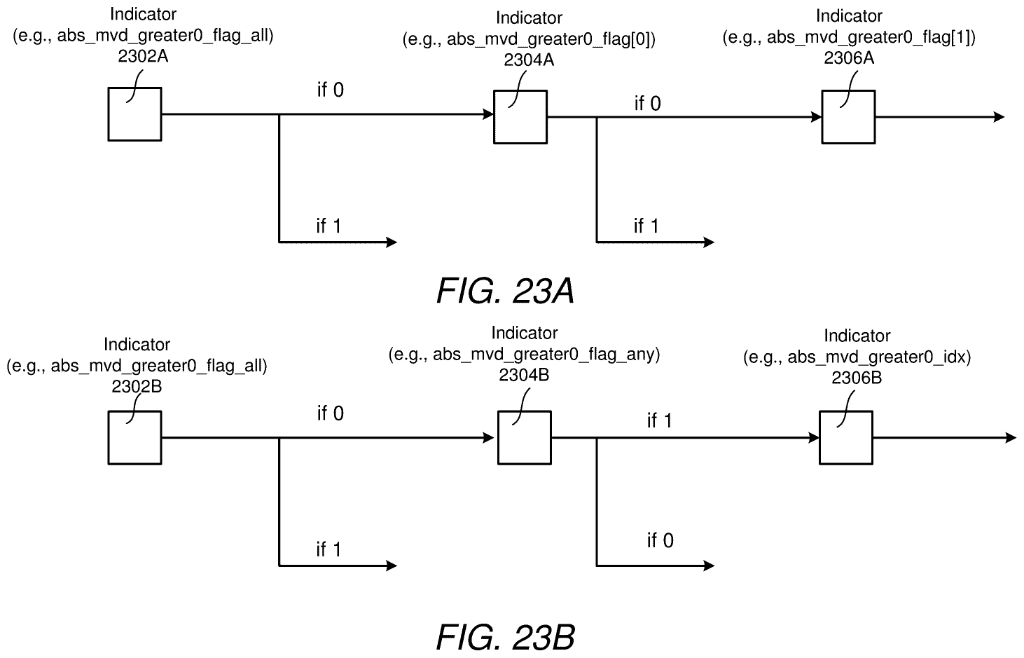

FIG. 23A illustrates an example of an indicator that jointly indicates whether a first component of the MVD is greater than zero and whether a second component of the MVD is greater than zero, according to some embodiments. Indicators 2302A, 2304A, and 2306A may replace the greater-than-zero indicators used in existing technologies. In some examples, each of indicators 2302A, 2304A, and 2306A may be context coded using an arithmetic coder such as CABAC, as described in FIG. 18.

In some examples, an indicator 2302A (e.g., abs_mvd_greater0_flag_all) may jointly indicate whether both the horizontal and vertical components of an MVD are not equal to 0 (which is logically equivalent to whether absolute values of both components being greater than 0). For example, a binary value of 1 for indicator 2302A may be signaled when both components are non-zero and a binary value of 0 may be signaled when at least one component of the MVD (either horizontal or vertical component) is zero. Thus, as shown in FIG. 23A, indicator 2302A is a single indictor that indicates whether each component of the MVD is not zero or equivalently that an absolute value of each component of the MVD is greater than zero.

In these example, one or more subsequent indicators may be indicated (and parsed by the decoder) depending on a value of a preceding indicator. For example, based on indicator 2302A being true or 1, then the MVD is zero (e.g., each of the horizontal and vertical components is zero) and subsequent indicator 2304A and indicator 2306A may be skipped and not parsed or indicated.

If indicator 2302A indicates that at least one component is none zero (or an absolute value of at least one component is greater than zero), indicator 2304A (e.g., abs_mvd_greater0_flag[0]) may be transmitted by the encoder and similarly parsed by the decoder. In an example, indicator 2304A indicates whether a first component (e.g., horizontal component) of the MV is non-zero. If indicator 2304A indicates that the first component is non-zero, then indicator 2306A may be skipped because if indicator 2302A indicates not both components are zero and indicator 2304A indicates the horizontal component is non-zero, then a second component (e.g., vertical component) of the MV must be zero and can be derived or assigned.

Indicator 2306A (e.g., abs_mvd_greater0_flag[1]) may be indicated by the encoder and/or parsed by the decoder if indicator 2304A indicates that the first component is equal to zero. Indicator 2306A may indicate whether the second component is zero (or equivalently whether an absolute value of the second component is greater than zero).

Therefore, FIG. 23A illustrates than indicators 2304A and 2306A may be conditionally indicated or parsed depending on a value of a previous indicator. By following the scheme described in FIG. 23A, the combination, for corresponding to the existing greater-than-0 indicators for the horizontal and vertical components, may be coded using one, two, or three indicators corresponding to combinations of values in decreasing probabilities of occurring. For example, a first combination of values with the highest probability of occurring (e.g., both greater-than-0 indicators being 1 in some sample video content) may be coded using one indicator 2302A and a second combination of values with the lowest probability of occurring (e.g., both greater-than-0 indicators being 0 in some sample video content) may be coded using a sequence of three indicators 2302A, 2304A, and 2306A.

FIG. 23B illustrates an example of an indicator (e.g., shown as one or a single indicator) that jointly indicates whether a first component of the MVD is greater than zero and whether a second component of the MVD is greater than zero, according to some embodiments. Indicators 2302B, 2304B, and 2306B may replace the greater-than-zero indicators used in existing technologies. In some examples, each of indicators 2302A, 2304A, and 2306A may be context coded using an arithmetic coder such as CABAC, as described in FIG. 18.

In some examples and similar to indicator 2302A in FIG. 23A, an indicator 2302B (e.g., abs_mvd_greater0_flag_all) may jointly indicate whether both the horizontal and vertical components of an MVD are not equal to 0 (which is logically equivalent to whether absolute values of both components being greater than 0). For example, a binary value of 1 for indicator 2302B may be signaled when both components are non-zero and a binary value of 0 may signaled when at least one component of the MVD (either horizontal or vertical component) is zero.

In these example, one or more subsequent indicators may be indicated (and parsed by the decoder) depending on a value of a preceding indicator. For example, based on indicator 2302B being true or 1, then the MVD is zero and subsequent indicator 2304B and indicator 2306B may be skipped.

If indicator 2302B indicates that at least one component is none zero (or an absolute value of at least one component is greater than zero), indicator 2304B (abs_mvd_greater0_flag_any) may be transmitted by the encoder and similarly parsed by the decoder. In an example, indicator 2304B indicates whether both of the components (horizontal and vertical) of the MVD are zero.

If indicator 2304B indicates that both components are zero, then indicator 2306B (abs_mvd_greater0_idx) may be skipped. Otherwise, if indicator 2304B indicates that not both components are zero, then indicator 2306B may be indicated or parsed. In some examples as described above, because indicator 2304B may be more likely to be 1 (or it is not as likely that both components of the MVD are zero), a context (or probability model) may be selected for coding indicator 2304B with a higher probability for the value of 1. Accordingly, further compression efficiency may be achieved.

Indicator 2306B (e.g., abs_mvd_greater0_idx) indicates which component of the horizontal and vertical components of the MVD is not equal to zero (i.e., has an absolute value greater than zero). For example, indicator 2306B may have one of two values: a first value (e.g., a binary 0) indicating that the horizontal component of the MVD is non-zero and the vertical component is zero; or a second value (e.g., a binary 1) indicating that the horizontal component of the MVD is non-zero and vertical component is zero. In a separate example, the second value may be 0 and the first value may be 1.

Therefore, FIG. 23B illustrates than indicators 2304B and 2306B may be conditionally indicated or parsed depending on a value of a previous indicator. By following the scheme described in FIG. 23B, the combination of values, corresponding to the existing greater-than-0 indicators for the horizontal and vertical components, that has a highest probability of occurring may be coded using only one indicator, which is more efficient than the two greater-than-0 indicators for the horizonal and vertical components of the MVD used in existing technologies.

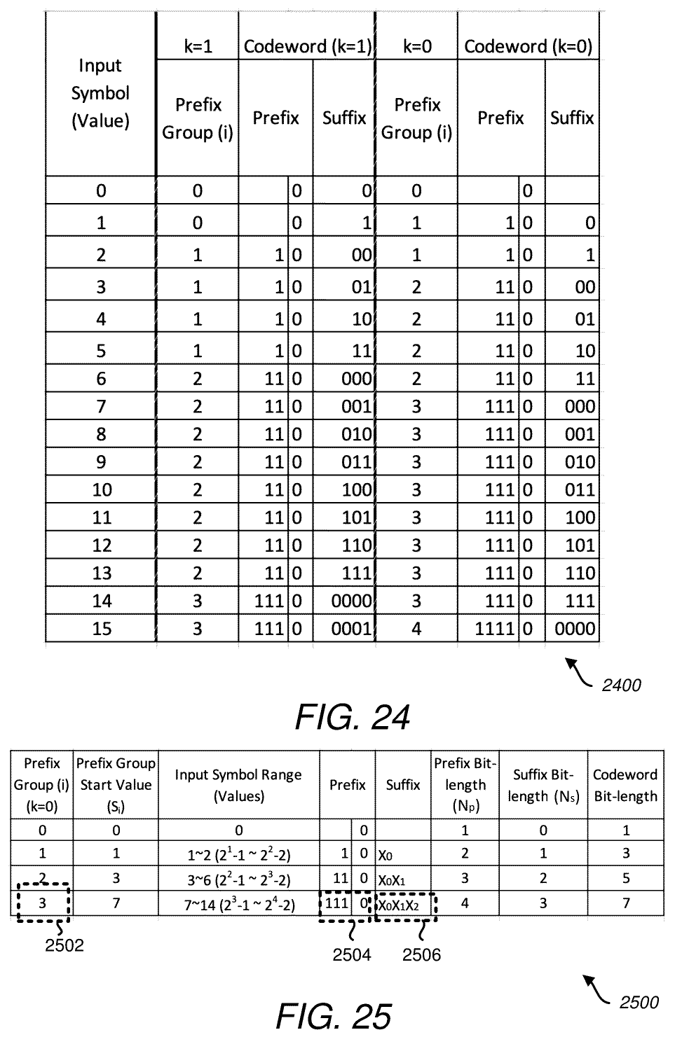

FIG. 24 is a table 2400 illustrating an example Ex-Golomb code (for the parameter k=1 and k=0) used for coding a vector difference such as a BVD or an MVD, according to some embodiments. Specifically, table 2400 shows an Exp-Golomb code, which is a prefix code (also referred to as a prefix-free code, a prefix condition code, or an instantaneous code). As shown in FIG. 24, codewords may be generated to correspond to values of input symbols. Each codework has a prefix part and a suffix part that may be determined as discussed above.

Based on table 2400, it can be observed that Exp-Golomb codes have certain properties. For example, the length or bit-length of prefix may be determined to be the number of continuous 1's (i) plus 1 (i.e., corresponding to the termination bit of 0) and can be represented as follows:

$${N}_{p} = i + 1 . \qquad ( 29 )$$

For example, in prefix group i (or for the (i+1)-th prefix value), the prefix value vₚ is represented in binary as i continuous 1s shifted left by k bits and corresponds to a value equal to 2^{k}(2ⁱ−1) or:

$${v}_{p} = {2}^{k} ( {2}^{i} - 1 ) = {2}^{k} ( {2}^{Np - 1} - 1 ) . \qquad ( 30 )$$

For example, the bit-length of the suffix part (Nₛ) for a prefix group i is (k+i), which is equivalent to (25). For example, for a prefix group i, the suffix value (Vₛ) may be a binary coded value that represents a range from 0 to 2^{k+i}−1. In other words, the size of the prefix group i may correspond to the number of values representable by the suffix value (vₛ) and may be determined as follows based on i or the bit-length of the prefix (Nₚ):

$${P}_{s} = {2}^{k + i} = {2}^{k + i} = {2}^{k + Np - 1} . \qquad ( 31 )$$

A prefix value (vₚ), which correspond to a prefix group, therefore indicates a range of values with the size (or total number of elements) of Pₛ as in (31).

In some embodiments, based on one or more of these properties, the codeword (being binarized using the Exp-Golomb code) may be decoded. In an example, the prefix part may be decoded based on a number i of leading 1s before the termination bit (e.g., 0). The prefix part may be decoded as having a prefix value that is vₚ=2^{k}(2ⁿ^{ₚ}⁻¹−1), which is equivalent to (30). In an example, based on decoding the prefix part, the suffix part can be decoded/debinarized based on a bit-length of the suffix (Nₛ) indicated by the prefix part. For example, the suffix part can be debinarized based on parsing the next (k+i) bits as representing a suffix value of the suffix part, as shown in (25). For example, these bits may be a binary coded representation of the suffix value.

As discussed above, in a Golomb code (e.g., the Exp-Golomb code), a codeword may include a prefix part and a suffix part that together represents an input symbol such as the BVD. (e.g., the BVD). As described above, the BVD may indicate a difference between a BVP and a BV and the MVD may indicate a difference between an MVP and an MV. The BVD and the MVD may be coded using a prefix and a suffix as shown in FIG. 24.

FIG. 25 illustrates an example table showing bit-lengths of codewords of an entropy code used for coding a vector difference such as a BVD or an MVD, according to some embodiments. Specifically, table 2500 shows an example of Exp-Golomb code with k^{th} order 0 that maps a set of input symbols to a prefix part and a suffix part. If the BVD is equal to a value of 12, then the BVD value may be a value in a range of BVD values indicated by prefix group 2502 (e.g., i=3). The BVD value of 12 may be represented by a codeword including prefix part 2504 including a prefix value of “1110”, which includes a unary value of “111” followed by a termination bit of value “0.” In some embodiments, the prefix value corresponds to a start value S (i.e., the minimum value) of the range of values indicated by the prefix part. As discussed above, the prefix value may be decoded as and/or correspond to vₚ=2^{k}(2^{N}^{ₚ}⁻¹−1), as shown in (30). The prefix value may indicate a range of values from Si˜(Sᵢ₊₁−1). Since in Exp-Golomb codes, a sequence of prefix values corresponds to a sequence of prefix group sizes (i.e., sizes of indicated ranges of values) in increasing powers of 2, the beginning value in a range of values indicated by a prefix value may correspond to a sum of the ranges of values being represented by all prefix values less than the prefix value. In other words, the starting prefix value Si of i-th prefix group may correspond to the prefix value as follows:

$${s}_{i} = {v}_{p} = {2}^{k} ( {2}^{i} - 1 ) = {2}^{k} ( {2}^{Np - 1} - 1 ) . \qquad ( 32 )$$

The column “Prefix” represents the prefix part as unary coded, while the prefix value (equivalent to prefix group start S) represents the value coded by the prefix part. The codeword may include suffix part 2506 of three bits (e.g., “101” as shown table 2400.)

As explained above, an important property of entropy coding is to compress a sequence of symbols by representing symbols with greater probability of occurring using fewer bits than symbols with less probability of occurring. For video compression, smaller values tend to occur more likely and therefore should be coded using less bits compared to larger values. An Ex-Golomb code achieves this by coding exponentially more codewords for each successive prefix group. In other words, and as observed in FIG. 25, the bit-length of codewords increases linearly for increasing prefix values in the prefix part, but the range of values (indicated by and coded in association with each prefix value) increases exponentially (e.g., an exponent of 2 in this case).

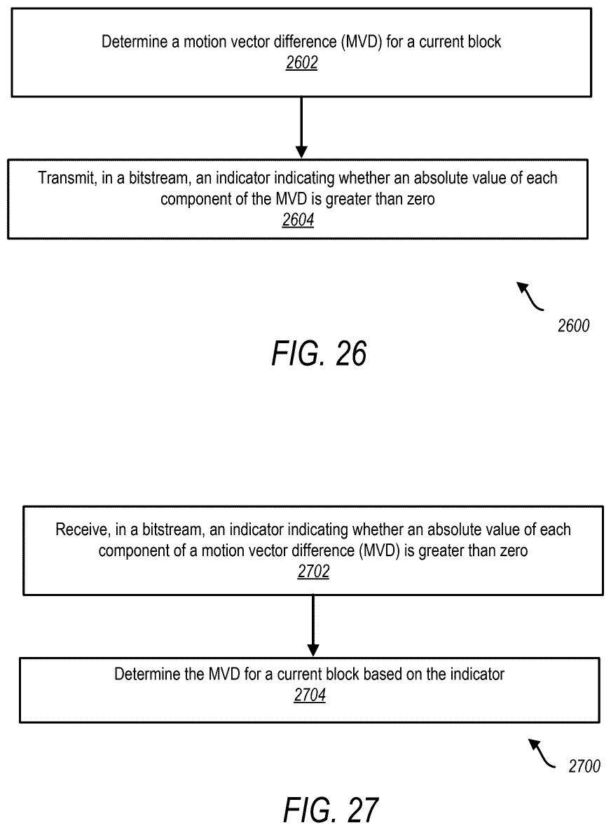

FIG. 26 illustrates a flowchart 2600 of a method for encoding an MVD, according to some embodiments. The method of flowchart 2600 may be implemented by an encoder (e.g., encoder 200 in FIG. 2). The operations shown in flowchart 2600 may be similarly applicable to a BVD, as described above.

At block 2602, an encoder determines a motion vector difference (MVD) for a current block. The MVD includes a horizontal component and a vertical component. In some examples, determining the MVD may include first determining whether an absolute value of a horizontal component of the MVD is greater than zero and second determining (which may be performed before the first determining) whether an absolute value of a vertical component of the MVD is greater than zero.

At block 2604, the encoder transmits, in a bitstream, an indicator indicating whether an absolute value of each component of the MVD is greater than zero (or equivalently whether each component of the MVD is non-zero). In an example, the indicator indicates whether an absolute value of each of the horizontal component and the vertical component is greater than zero. As described above in FIG. 23A and FIG. 23B, the indication may correspond to and represent a combination of values for the greater-than-zero indicators, in existing technologies, with a highest probability of occurring. In other words, in another example such as for coding certain types of content, the indicator may instead indicate that each component of the MVD is equal to zero.

In some examples, the indicator may be based on the first determining and the second determining in block 2602.

In some examples, the encoder may encode and transmit the syntax elements as shown and described above with respect to FIG. 19 for MVD and FIG. 20 for BVD.

In some examples, the transmitting the indicator includes arithmetic encoding a value of the indicator. For example, the value may be a binary 0 or a binary 1.

FIG. 27 illustrates a flowchart 2700 of a method for decoding an MVD, according to some embodiments. The method of flowchart 2700 may be implemented by a decoder (e.g., decoder 300 in FIG. 3). The operations shown in flowchart 2700 may be similarly applicable to a BVD, as described above.

At block 2702, a decoder receives, in a bitstream, an indicator indicating whether an absolute value of each component of a motion vector difference (MVD) is greater than zero.

In some embodiments, the indicator may be indicator 2302A as described in FIG. 23A. For example, based on the indicator, the decoder may determine whether to parse a second indicator (e.g., indicator 2304A) indicating whether an absolute value of a first component of the MVD is greater than zero. For example, the decoder may determine a presence (or absence) of the second indicator based on the indicator. The decoder may skip parsing of the second indicator in response to the indicator indicating the absolute value of each component of the MVD to be greater than zero. In this example, the decoder may determine the second indicator is absent based on the indicator and therefore does not need to be parsed.

In some examples, based on the determining to parse the second indicator (e.g., that the second indicator is present in the bitstream), the decoder may receive (and parse) the second indicator. Based on the indicator and the second indicator indicating the absolute value of the first component of the MVD being greater than zero, the decoder may determine that: the absolute value of the first component of the MVD is greater than zero; and the absolute value of a second component of the MVD is not greater than zero. The decoder may skip parsing, in response to the second indicator indicating the absolute value of the first component is greater than zero, a third indicator (e.g., indicator 2306A) indicating whether the absolute value of the second component is greater than zero.

In some examples, based on the determining to parse the second indicator, the decoder may receive (and parse) the second indicator. Based on the indicator and the second indicator indicating the absolute value of the first component of the MVD is not greater than zero, the decoder may receive (and parse) the third indicator indicating whether the absolute value of the second component is greater than zero. The decoder may determine, based on the indicator and the second indicator, the absolute value of the first component of the MVD is not greater than zero. The decoder may determine, based on the third indicator, whether the absolute value of a second component of the MVD is greater than zero.

In some embodiments, the indicator may be indicator 2302B as described in FIG. 23B. For example, the decoder may determine, based on the indicator, whether to parse a second indicator (e.g., indicator 2304B) indicating whether an absolute value of at least one component of the MVD is greater than zero. The decoder may skip parsing the second indicator in response to the indicator indicating the absolute value of each component of the MVD to be greater than zero.

In some examples, based on the determining to parse the second indicator, the decoder may receive (and parse) the second indicator. Based on the indicator and the second indicator indicating that none of the components of the MVD has an absolute value greater than zero, the decoder may determine that: the absolute value of the first component of the MVD is not greater than zero; and the absolute value of a second component of the MVD is not greater than zero. In an example, the decoder may skip parsing, in response to the second indicator indicating that none of the components has an absolute value greater than zero, a third indicator (e.g., indicator 2306B) indicating whether a first component or a second component of the MVD has an absolute value greater than zero. In other words, the third indicator may indicate which of the first component or the second component of the MVD has an absolute value that is greater than zero.

In some examples, based on the determining to parse the second indicator, the decoder may receive (and parse) the second indicator. The decoder may receive, based on the indicator and the second indicator indicating the absolute value of at least one component of the MVD is greater than zero, a third indicator indicating whether a first component or a second component of the MVD has an absolute value greater than zero. In other words, the third indicator may indicate which of the first component or the second component of the MVD has an absolute value that is greater than zero. Based on the second indicator and the third indicator indicating the first component having an absolute value greater than zero, the decoder may determine that: the absolute value of the first component of the MVD is greater than zero; and the absolute value of the second component of the MVD is not greater than zero.

In some examples, receiving the second indicator includes: selecting a probability model, from probability models, for the second indicator, and arithmetic decoding a value of the second indicator based on the probability model.

In some examples, the indicator may jointly include information not only for the MVD, but also for one or more components of other MVDs. For example, the indicator may further indicates whether an absolute value of each component of a second MVD is greater than zero. For example, the indicator being a first predetermined value may indicate that each component of the first MVD and the second MVD is greater than zero.

At block 2704, the decoder determines an MVD for a current block based on the indicator. For example, the decoder may parse the syntax elements as shown and described above with respect to FIG. 19 for MVD and FIG. 20 for BVD.

In some examples, based on a value of the indicator, the decoder may determine whether both: the absolute value of a horizontal component of the MVD is greater than zero; and the absolute value of a vertical component of the MVD is greater than zero. For example, the value may be one of a binary 0 or a binary 1.

In some examples, determining the MVD includes: determining, based on the indicator, a value of a horizontal component of the MVD; and determining, based on the indicator, a value of a vertical component of the MVD.

In some examples, the decoder may reconstruct the current block (coded by the encoder) based on the determined MVD. For example, the decoder may determine a reference block based on an MV determined from the MVD and the MVP. Then, the decoder may combine the reference block with residual information (e.g., residual of the current block received and decoded from the bitstream) to determine the current block.

In some examples, the receiving the indicator includes arithmetic decoding a value of the indicator based on a probability model selected for the indicator. The decoded value may be one of a binary 0 or a binary 1.

The following features may be applicable both to how the encoder encodes and the decoder decodes MVDs and BVDs, as described above with respect to FIG. 26 and FIG. 27.

In some examples, the indicator is one symbol. For example, the indicator may be one binary symbol.

As described above, the indicator may correspond to a specific combination of values of the greater-than-zero indicators, for the horizontal and vertical components of the MVD used in existing technologies, with a highest probability of occurring.

In a first example, based on the indicator being a first value: each component of the MVD has an absolute value that is greater than zero; and based on the indicator being not the first value: at least one component of the MVD has an absolute value that is not greater than zero.

In a second example, based on the indicator being a first value: each component of the MVD has an absolute value that is not greater than zero; and based on the indicator not being the first value: at least one component of the MVD has an absolute value that is greater than zero.

In a third example, based on the indicator being a first value: a first component of the MVD has an absolute value that is greater than zero; and a second component of the MVD has an absolute value that is not greater than zero. And based on the indicator not being the first value, at least: the first component of the MVD has an absolute value that is not greater than zero; or the second component of the MVD has an absolute value that is greater than zero.

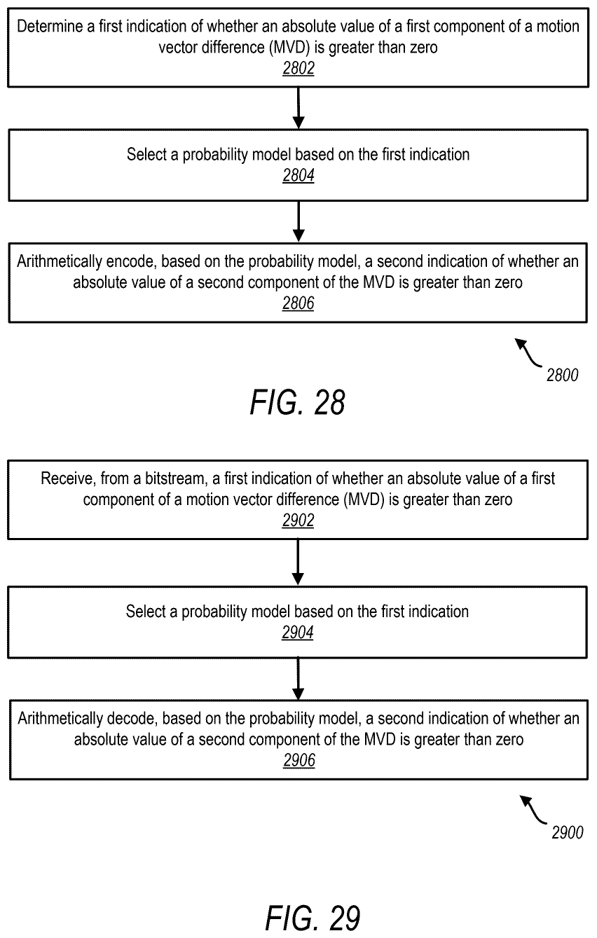

FIG. 28 illustrates a flowchart 2800 of a method for encoding an MVD, according to some embodiments. The method of flowchart 2800 may be implemented by an encoder (e.g., encoder 200 in FIG. 2). The operations shown in flowchart 2800 may be similarly applicable to a BVD, as described above.

At block 2802, an encoder determines a first indication of whether an absolute value of a first component of a motion vector difference (MVD) is greater than zero.

At block 2804, the encoder selects a probability model based on the first indication.

At block 2806, the encoder arithmetic encoding, based on the probability model, a second indication of whether an absolute value of a second component of the MVD is greater than zero.

FIG. 29 illustrates a flowchart 2900 of a method for decoding an MVD, according to some embodiments. The method of flowchart 2900 may be implemented by a decoder (e.g., decoder 300 in FIG. 3). The operations shown in flowchart 2900 may be similarly applicable to a BVD, as described above.

At block 2902, a decoder receives, from a bitstream, a first indication of whether an absolute value of a first component of a motion vector difference (MVD) is greater than zero.

At block 2904, the decoder selects a probability model based on the first indication. In some examples, the probability model is selected from a first probability model and a second probability model, as described above in FIG. 22. For example, the probability model may be the first probability model when the first indication indicates the absolute value of the first component is greater than zero, and the probability model may be the second probability model when the first indication indicates the absolute value of the first component is not greater than zero.

In some examples, the first component is one of a horizontal component or a vertical component, and the second component is the other component. For example, if the first component is the horizontal component of the MVD, then the second component is the vertical component of the MVD, or vice versa.

At block 2906, the decoder arithmetic decodes, based on the probability model, a second indication of whether an absolute value of a second component of the MVD is greater than zero.

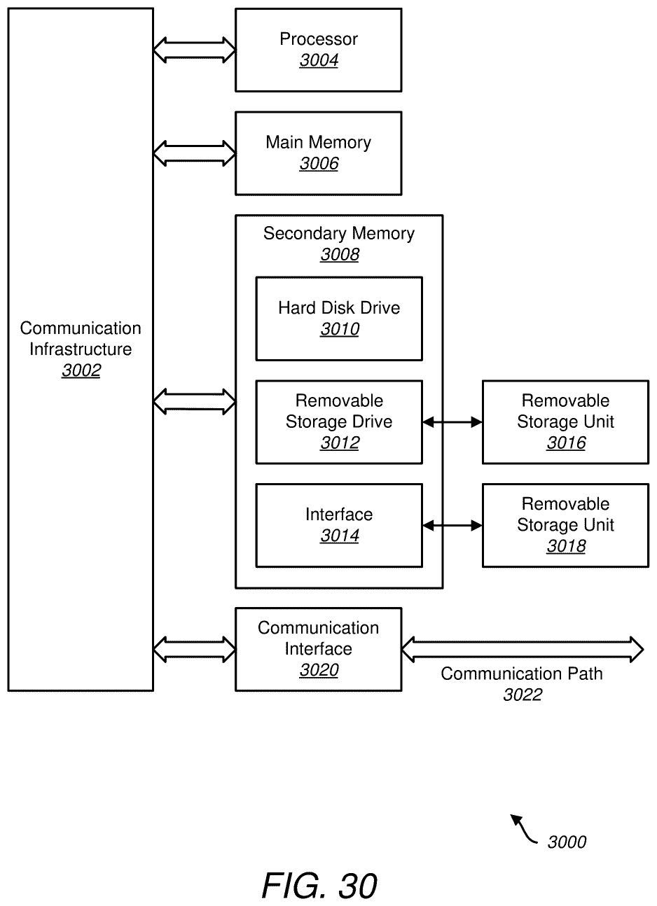

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 3000 is shown in FIG. 30. Blocks depicted in the figures above, such as the blocks in FIGS. 1, 2, and 3, may execute on one or more computer systems 3000. Furthermore, each of the steps of the flowcharts depicted in this disclosure may be implemented on one or more computer systems 3000.

Computer system 3000 includes one or more processors, such as processor 3004. Processor 3004 may be, for example, a special purpose processor, general purpose processor, microprocessor, or digital signal processor. Processor 3004 may be connected to a communication infrastructure 3002 (for example, a bus or network). Computer system 3000 may also include a main memory 3006, such as random access memory (RAM), and may also include a secondary memory 3008.

Secondary memory 3008 may include, for example, a hard disk drive 3010 and/or a removable storage drive 3012, representing a magnetic tape drive, an optical disk drive, or the like. Removable storage drive 3012 may read from and/or write to a removable storage unit 3016 in a well-known manner. Removable storage unit 3016 represents a magnetic tape, optical disk, or the like, which is read by and written to by removable storage drive 3012. As will be appreciated by persons skilled in the relevant art(s), removable storage unit 3016 includes a computer usable storage medium having stored therein computer software and/or data.

In alternative implementations, secondary memory 3008 may include other similar means for allowing computer programs or other instructions to be loaded into computer system 3000. Such means may include, for example, a removable storage unit 3018 and an interface 3014. Examples of such means may include a program cartridge and cartridge interface (such as that found in video game devices), a removable memory chip (such as an EPROM or PROM) and associated socket, a thumb drive and USB port, and other removable storage units 3018 and interfaces 3014 which allow software and data to be transferred from removable storage unit 3018 to computer system 3000.

Computer system 3000 may also include a communications interface 3020. Communications interface 3020 allows software and data to be transferred between computer system 3000 and external devices. Examples of communications interface 3020 may include a modem, a network interface (such as an Ethernet card), a communications port, etc. Software and data transferred via communications interface 3020 are in the form of signals which may be electronic, electromagnetic, optical, or other signals capable of being received by communications interface 3020. These signals are provided to communications interface 3020 via a communications path 3022. Communications path 3022 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 3016 and 3018 or a hard disk installed in hard disk drive 3010. These computer program products are means for providing software to computer system 3000. Computer programs (also called computer control logic) may be stored in main memory 3006 and/or secondary memory 3008. Computer programs may also be received via communications interface 3020. Such computer programs, when executed, enable the computer system 3000 to implement the present disclosure as discussed herein. In particular, the computer programs, when executed, enable processor 3004 to implement the processes of the present disclosure, such as any of the methods described herein. Accordingly, such computer programs represent controllers of the computer system 3000.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
receiving, in a bitstream, one indicator indicating whether an absolute value of each component of a difference vector for a current block is greater than zero, wherein the difference vector is a motion vector difference (MVD) or a block vector difference (BVD);
determining the difference vector based on the one indicator; and
reconstructing the current block based on the difference vector.

2. The method of claim 1, wherein:
the difference vector is a first MVD;
based on the one indicator being a predetermined value, the one indicator indicates that an absolute value of each component of the first MVD and a second MVD is greater than zero; and
the current block is reconstructed based on the first MVD and the second MVD.

3. The method of claim 1, wherein the one indicator is one binary symbol, and wherein the determining the difference vector comprises:
based on the one indicator being a first value, determining each component of the difference vector has an absolute value that is greater than zero; and
based on the one indicator not being the first value, determining at least one component of the difference vector has an absolute value that is not greater than zero.

4. The method of claim 1, wherein the one indicator is one binary symbol, and wherein the determining the difference vector comprises:
based on the one indicator being a first value, determining each component of the difference vector has an absolute value that is not greater than zero; and
based on the one indicator not being the first value, determining at least one component of the difference vector has an absolute value that is greater than zero.

5. The method of claim 1, further comprising determining, based on the one indicator, whether to parse from the bitstream a second indicator indicating whether an absolute value of a first component of the difference vector is greater than zero, wherein the second indicator being a first value indicates:
the absolute value of the first component of the difference vector is greater than zero; and
the absolute value of a second component of the difference vector is not greater than zero.

6. The method of claim 5, wherein, based on determining to parse the second indicator from the bitstream, the method further comprises:
arithmetic decoding the second indicator from the bitstream; and
arithmetic decoding, from the bitstream and based on the second indicator being a second value indicating the absolute value of the first component of the difference vector is not greater than zero, a third indicator indicating whether the absolute value of the second component of the difference vector is greater than zero.

7. The method of claim 1, further comprising determining, based on the one indicator, whether to parse from the bitstream a second indicator indicating whether at least one component of the difference vector has an absolute value that is greater than zero, wherein the second indicator being a first value indicates:
the absolute value of a first component of the difference vector is not greater than zero; and
the absolute value of a second component of the difference vector is not greater than zero.

8. A decoder comprising:
one or more processors; and
memory storing instructions that, when executed by the one or more processors, cause the decoder to:
receive, in a bitstream, one indicator indicating whether an absolute value of each component of a difference vector for a current block is greater than zero, wherein the difference vector is a motion vector difference (MVD) or a block vector difference (BVD);
determine the difference vector based on the one indicator; and
reconstruct the current block based on the difference vector.

9. The decoder of claim 8, wherein:
the difference vector is a first MVD;
based on the one indicator being a predetermined value, the one indicator indicates that an absolute value of each component of the first MVD and a second MVD is greater than zero; and
the current block is reconstructed based on the first MVD and the second MVD.

10. The decoder of claim 8, wherein the one indicator is one binary symbol, and wherein, to determine the difference vector, the decoder is further caused to:
based on the one indicator being a first value, determine each component of the difference vector has an absolute value that is greater than zero; and
based on the one indicator not being the first value, determine at least one component of the difference vector has an absolute value that is not greater than zero.

11. The decoder of claim 8, wherein the one indicator is one binary symbol, and wherein, to determine the difference vector, the decoder is further caused to:
based on the one indicator being a first value, determine each component of the difference vector has an absolute value that is not greater than zero; and
based on the one indicator not being the first value, determine at least one component of the difference vector has an absolute value that is greater than zero.

12. The decoder of claim 8, wherein the decoder is further caused to determine, based on the one indicator, whether to parse from the bitstream a second indicator indicating whether an absolute value of a first component of the difference vector is greater than zero, wherein the second indicator being a first value indicates:
the absolute value of the first component of the difference vector is greater than zero; and
the absolute value of a second component of the difference vector is not greater than zero.

13. The decoder of claim 12, wherein, based on determining to parse the second indicator from the bitstream, the decoder is further caused to:
arithmetic decode the second indicator from the bitstream; and
arithmetic decode, from the bitstream and based on the second indicator being a second value indicating the absolute value of the first component of the difference vector is not greater than zero, a third indicator indicating whether the absolute value of the second component of the difference vector is greater than zero.

14. The decoder of claim 8, wherein the decoder is further caused to determine, based on the one indicator, whether to parse from the bitstream a second indicator indicating whether at least one component of the difference vector has an absolute value that is greater than zero, wherein the second indicator being a first value indicates:
the absolute value of a first component of the difference vector is not greater than zero; and
the absolute value of a second component of the difference vector is not greater than zero.

15. A non-transitory computer-readable medium comprising instructions that, when executed by one or more processors of a decoder, cause the decoder to:
receive, in a bitstream, one indicator indicating whether an absolute value of each component of a difference vector for a current block is greater than zero, wherein the difference vector is a motion vector difference (MVD) or a block vector difference (BVD);
determine the difference vector based on the one indicator; and
reconstruct the current block based on the difference vector.

16. The non-transitory computer-readable medium of claim 15, wherein:
the difference vector is a first MVD;
based on the one indicator being a predetermined value, the one indicator indicates that an absolute value of each component of the first MVD and a second MVD is greater than zero; and
the current block is reconstructed based on the first MVD and the second MVD.

17. The non-transitory computer-readable medium of claim 15, wherein the one indicator is one binary symbol, and wherein, to determine the difference vector, the decoder is further caused to:
based on the one indicator being a first value, determine each component of the difference vector has an absolute value that is greater than zero; and
based on the one indicator not being the first value, determine at least one component of the difference vector has an absolute value that is not greater than zero.

18. The non-transitory computer-readable medium of claim 15, wherein the one indicator is one binary symbol, and wherein, to determine the difference vector, the decoder is further caused to:
based on the one indicator being a first value, determine each component of the difference vector has an absolute value that is not greater than zero; and
based on the one indicator not being the first value, determine at least one component of the difference vector has an absolute value that is greater than zero.

19. The non-transitory computer-readable medium of claim 15, wherein the decoder is further caused to determine, based on the one indicator, whether to parse from the bitstream a second indicator indicating whether an absolute value of a first component of the difference vector is greater than zero, wherein the second indicator being a first value indicates:
the absolute value of the first component of the difference vector is greater than zero; and
the absolute value of a second component of the difference vector is not greater than zero.

20. The non-transitory computer-readable medium of claim 15, wherein the decoder is further caused to determine, based on the one indicator, whether to parse from the bitstream a second indicator indicating whether at least one component of the difference vector has an absolute value that is greater than zero, wherein the second indicator being a first value indicates:
the absolute value of a first component of the difference vector is not greater than zero; and
the absolute value of a second component of the difference vector is not greater than zero.
